(19) United States
(12) Patent Application Publication
(10) Pub. No.: US 2026/0303148 A1
(43) Pub. Date: Oct. 1, 2026

(54) METHODS AND APPARATUS FOR ECHO CANCELLATION IN TRANSCEIVERS

(71) Applicant: Texas Instruments Incorporated, Dallas, TX (US)

(72) Inventors: Surya Theja Golakonda, Sunnyvale, CA (US); Ramsin Ziazadeh, San Jose, CA (US); Ashwin Ramachandran, Santa Clara, CA (US)

(21) Appl. No.: 19/096,198

(22) Filed: Mar. 31, 2025

(51) Int. Cl. H04B 3/23; H04L 5/14

(52) U.S. Cl. CPC H04B 3/23; H04L 5/1461

(57) ABSTRACT

An example apparatus includes a first resistor; a second resistor coupled to the first resistor; a first transistor having a first terminal coupled to the first resistor and second resistor; a second transistor having a terminal coupled to the first terminal of the first transistor; a third resistor; a fourth resistor coupled to the third resistor; a third transistor having a first terminal coupled to the control terminal of the first transistor, a second terminal coupled to the third resistor and the fourth resistor, and a control terminal coupled to the first terminal of the first transistor and to the terminal of the second transistor; and a fourth transistor having a terminal coupled to the first terminal of the third transistor and to the control terminal of the first transistor, and a control terminal coupled to control terminal of the second transistor.

### TECHNICAL FIELD

This description relates generally to transceivers and, more particularly, to methods and apparatus for echo cancellation in transceivers.

### BACKGROUND

In communication systems, devices exchange data by transmitting and receiving signals. Such devices include transceivers having transmitter circuitry and receiver circuitry. Transmitter circuitry of a first device transmits signals to receiver circuitry of a second device across a communication channel. In full-duplex communication systems, multiple devices may transmit signals simultaneously along the communication channel. Devices can support simultaneous communication by implementing additional circuitry in the transmitter, such as echo cancellation, impedance matching, etc.

### SUMMARY

For methods and apparatus for echo cancellation, an example apparatus includes a first resistor; a second resistor coupled to the first resistor; a first transistor having a first terminal, a second terminal, and a control terminal, the second terminal of the first transistor coupled to the first resistor and second resistor; a second transistor having a first terminal, a second terminal, and a control terminal, the second terminal of the second transistor coupled to the first terminal of the first transistor; a third resistor; a fourth resistor coupled to the third resistor; a third transistor having a first terminal, a second terminal, and a control terminal, the first terminal coupled to the control terminal of the first transistor, the second terminal of the third transistor coupled to the third resistor and the fourth resistor, and the control terminal of the third transistor coupled to the first terminal of the first transistor and to the second terminal of the second transistor; and a fourth transistor having a first terminal, a second terminal, and a control terminal, the second terminal of the fourth transistor coupled to the first terminal of the third transistor and to the control terminal of the first transistor, the control terminal of the fourth transistor coupled to control terminal of the second transistor. Other examples are described.

For methods and apparatus for echo cancellation, an example apparatus includes combination circuitry having: a first resistor having a first terminal and a second terminal; a second resistor having a first terminal and a second terminal, the second terminal of the second resistor coupled to the second terminal of the first resistor; a third resistor having a first terminal and a second terminal; a fourth resistor having a first terminal and a second terminal, the second terminal of the fourth resistor coupled to the second terminal of the third resistor; a fifth resistor having a first terminal and a second terminal, the first terminal of the fifth resistor coupled to the second terminal of the first resistor and the second terminal of the second resistor; and a sixth resistor having a first terminal and a second terminal, the first terminal of the sixth resistor coupled to the second terminal of the fifth resistor, the second terminal of the sixth resistor coupled to the second terminal of the third resistor and the second terminal of the fourth resistor. The apparatus also includes a comparator having a first input, a reference terminal, and an output, the first input of the comparator coupled to the second terminal of the fifth resistor and to the first terminal of the sixth resistor. The apparatus also includes a first current source coupled to the output of the comparator, to the second terminal of the first resistor, to the second terminal of the second resistor, and to the first terminal of the fifth resistor. The apparatus also includes a second current source coupled to the output of the comparator, to the second terminal of the third resistor, to the second terminal of the fourth resistor, and to the second terminal of the sixth resistor. Other examples are described.

For methods and apparatus for echo cancellation, an example system includes a communication channel having an output. The system also includes replica transmitter circuitry having an output. The system also includes combination circuitry including: voltage to current converter circuitry including a first resistor having a first terminal coupled to the output of the communication channel and a second terminal; a second resistor having a first terminal coupled to the output of the replica transmitter circuitry and a second terminal coupled to the second terminal of the first resistor; a third resistor having a first terminal coupled to the output of the communication channel and a second terminal; a fourth resistor having a first terminal coupled to the output of the replica transmitter circuitry and a second terminal coupled to the second terminal of the third resistor; virtual ground circuitry including: a first transistor having a first terminal, a second terminal, and a control terminal, the second terminal of the first transistor coupled to the second terminals of the first resistor and second resistor, a second transistor having a first terminal, a second terminal, and a control terminal, the second terminal of the second transistor coupled to the first terminal of the first transistor, a third transistor having a first terminal, a second terminal, and a control terminal, the first terminal coupled to the control terminal of the first transistor, the second terminal of the third transistor coupled to the second terminals of the third resistor and the fourth resistor, the, and the control terminal of the third transistor coupled to the first terminal of the first transistor and to the second terminal of the second transistor, and including a fourth transistor having a first terminal, a second terminal, and a control terminal, the second terminal of the fourth transistor coupled to the first terminal of the third transistor and to the control terminal of the first transistor, the control terminal of the fourth transistor coupled to control terminal of the second transistor. The system also includes receiver circuitry having an input, the input of the receiver circuitry coupled to the first terminal of the second transistor and to the first terminal of the fourth transistor. Other examples are described.

### BRIEF DESCRIPTION OF THE DRAWINGS

FIG. 1 is a block diagram of an example communication system including echo cancellation circuitry.

FIG. 2 is a block diagram of an example implementation of the echo cancellation circuitry of FIG. 1 including combination circuitry and common mode variation compensation circuitry.

FIG. 3 is a schematic diagram of the example combination circuitry of FIGS. 1 and 2.

FIG. 4 is a flowchart representative of example machine-readable instructions or example operations that may be at least one of executed, instantiated, or performed using an example implementation of the combination circuitry of FIGS. 1, 2, and 3.

FIGS. 5A and 5B are schematic diagrams of example implementations of the echo cancellation circuitry of FIGS. 1 and 2, including the common mode variation compensation circuitry.

FIG. 6 is a flowchart representative of example machine-readable instructions or example operations that may be at least one of executed, instantiated, or performed using an example implementation of the common mode variation compensation circuitry of FIGS. 1, 2, and 5.

FIG. 7 is a plot of example common mode voltages (V_{CMIN} and V_{CMOUT}) of primary transmitter circuitry of FIG. 1 and combination circuitry of FIGS. 1, 2, 3, and 5 during operation of the common mode variation compensation circuitry of FIGS. 1, 2, and 5.

FIG. 8 is a block diagram of an example vehicle including an example advanced driver-assistance (ADAS) system and an example in-vehicle infotainment (IVI) system.

FIG. 9 is a block diagram of an example of the ADAS system of FIG. 8 including example deserializer circuitry and example serializer circuitry.

FIG. 10 is a block diagram of an example of the IVI system of FIG. 8 including example serializer circuitry, and example deserializer circuitry.

FIG. 11 is a block diagram including examples of the serializer and deserializer circuitry of FIGS. 9 and 10, which may be referred to as a serial-deserializer (SerDes) system.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

In communication systems, devices exchange data by transmitting and receiving signals. Such devices include transceivers having transmitter circuitry and receiver circuitry. Transmitter circuitry of a first device transmits signals to receiver circuitry of a second device across a communication channel. In full-duplex communication systems, multiple devices may transmit signals simultaneously along the communication channel. In full-duplex communication systems, multiple devices may transmit signals simultaneously along the communication channel. As described above, devices can support simultaneous communication by implementing additional circuitry in the transmitter, such as echo cancellation.

In full duplex communication systems, devices include echo cancellation circuitry to remove locally transmitted signals from receiver circuitry of the device by subtracting the main transmitted signal from a replica version of the locally transmitted signal. The echo cancellation circuitry provides the remaining portions of communication signals to the receiver circuitry. In operation, the remaining portions of the communication signals represent data transmitted by another device across the communication channel. For example, in some systems, a device transmits front channel data and receives back-channel data plus the front channel data, referred to as the main signal. The echo cancellation circuitry provides just the back-channel data of the communication signal to the receiver circuitry of the device. The echo cancellation circuitry improves signal integrity of the back-channel data by reducing the contributions of the front-channel signal seen in the transmitted signals of back-channel signals at the input of the receiver circuitry.

Some devices implement echo cancellation using primary transmitter circuitry, secondary transmitter circuitry, and summing circuitry. The primary transmitter circuitry transmits signals (e.g., front channel data) by driving the communication channel and receives signals from the communication channel (e.g., a combination of the front channel data and back-channel data from another device). The secondary transmitter circuitry includes internal termination circuitry, which replicates an impedance of the communication channel. The secondary transmitter circuitry generates a replica of the transmitted signal of the primary transmitter circuitry responsive to driving the internal termination circuitry. The summing circuitry combines the signals from the communication channel and the replica signal, effectively subtracting the transmitted signal (e.g., front channel data) and the replica signal, resulting in signals received from another device (e.g., back-channel data). For example, the summing circuitry provides a communication signal representing the back-channel data to the receiver circuitry of the device. The receiver circuitry produces a serial data stream representing the back-channel data responsive to signals from the communication channel.

In some examples, summing circuitry is implemented by a differential pair of transistors and signals are combined in a voltage domain. A first transistor in the differential pair of transistors receives the signals from the communication channel, also referred to as the main signal, and a second transistor in the differential pair of transistors receives the inverse replica of the transmitted signal (e.g., front channel data) from the secondary transmitter circuitry, which may also be referred to as replica transmitter circuity. The differential pairs amplify a voltage difference between the two inputs of the first transistor and second transistor and rejects any common-mode voltage. Therefore, any signals corresponding to the front channel data are rejected, and the signals corresponding to the back-channel data are provided at the output of the summing circuitry.

Summing circuitry implemented by a differential pair of transistors suffers from non-linearity. Non-linearity of a circuit refers to a situation where the output signal is not directly proportional to the input signal, causing distortions at the output signal that degrade the quality of the output signal. For example, the back-channel data provided by the output of the differential pair of transistors may not accurately reflect the back-channel data provided by the device that propagated the data over the communication channel. In some examples, differential pairs suffer from non-linearity because transistors are affected by changes in voltage. For example, transistors have transconductance (gm) which represent how much the output current responds to a change in input voltage. In some examples, the transconductance of a transistor varies when there is a change in the input voltage, such as a large voltage swing. Therefore, while summing in the voltage domain using a differential pair of transistors is linear for some input voltages (e.g., at some relatively low voltage swings of the main signal and replica signal), it is non-linear for other input voltages, such as relatively large voltage swings. As a result, due to non-linear summation, echo (e.g., residual signals not corresponding to the back-channel data) at back-channel receiver circuitry becomes indistinguishable from back-channel data and, thus, back-channel data becomes lost.

In some examples, summing in voltage the voltage domain also becomes distorted when the summing circuitry is implemented in a device that transmits signals over a single-ended communication channel. For example, coaxial communication channels, serial link communication channels (e.g., flat panel display cables), etc. propagate signals using a single wire with reference to ground, whereas a full-duplex communication system propagates signals along a communication channel using a pair of wires, where the signal is represented by the voltage difference between the pair. The summing circuitry, which implements a differential pair of transistors for the complementary signals, lacks an input signal on one of the transistors, causing the output of the summer circuitry to be unbalanced. For example, one pair of transistors in the differential pair receive a main positive signal and a replica negative signal, and a second pair of transistors in the differential pair receive a main negative signal and a replica positive signal. In single-ended communication systems, the transistor structured to receive the main negative signal does not receive an input signal, while the transistor structured to receive the main positive signal does receive an input signal. This causes the output of the summing circuitry to be unbalanced, resulting in a distorted back-channel signal.

Also, in some examples, common mode variations from the primary transmitter circuitry (e.g., from the forward channel driver) degrade the echo rejection of the back-channel receiver. For example, if the common mode voltage of the primary transmitter changes or varies, a bias current of the summing circuitry changes. In some examples, when the bias current changes, operating points of the summing circuitry changes, such as changing how much current flows through the summing circuitry, which affects the output of the summing circuitry.

Examples described herein provide circuitry that performs echo cancellation in a current domain to reduce non-linearities of the summing circuitry and provide a clean communication signal representing back-channel data. Examples described herein use resistors to convert main signals and replica signals to current, where the current representing the replica signal is subtracted from current representing the main signal, resulting in a current representing back-channel data. Examples described herein also include virtual ground generation circuitry to maintain a stable reference point at a summing node. For example, examples described herein implement a transimpedance amplifier that generates a virtual ground at an input of the transimpedance amplifier and converting all of the current, representing back-channel data, to be converted to voltage at the output of the summing circuitry. The virtual ground ensures that the currents being combined to cancel out signals representing front channel data are not influenced by any changes in voltage near the summing node.

Examples described herein also include biquad filter circuitry that operates to reject frequencies outside of a bandwidth of the back-channel data. For example, frequencies outside of the bandwidth of the back-channel data occur due to rise fall mismatches between the primary and secondary transmitter circuitry and between the impedance of the communication channel and the impedance of the secondary transmitter circuitry termination. The biquad filter is implemented by tunable capacitors that are tuned to the bandwidth of the back-channel data and ensure residual frequencies are minimized from the back-channel data prior to output of the back-channel data. Examples described herein also include single to differential signal converter circuitry that operates to convert single-ended signals to differential signal to improve a balance of signals at the output of the summing circuitry. For example, examples described herein implement two complementary transistors that create a feed-forward path, effectively generating a complementary or differential signal at the summing node(s) of the summing circuitry. Examples disclosed herein also include resistor-capacitor (RC) circuitry that improves the differential signal by providing feedback to the virtual ground generation circuitry. Examples described herein also include common mode variation compensation circuitry which operates to restore an operating point or bias current of the summing circuitry to reduce or eliminate degradation at the output of the summing circuitry.

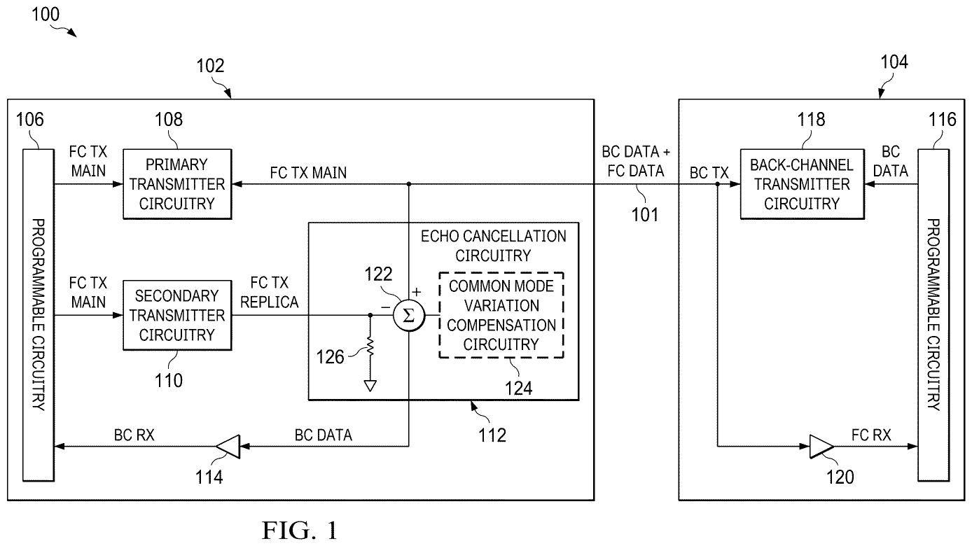

FIG. 1 is a block diagram of an example communication system 100 including an example first device 102 and an example second device 104 exchanging data by transmitting and receiving signals over a communication channel 101. In FIG. 1, the first device 102 includes example programmable circuitry 106, example primary transmitter circuitry 108, example secondary transmitter circuitry 110, example echo cancellation circuitry 112, and example receiver circuitry 114. In FIG. 1, the second device 104 includes example programmable circuitry 116, example back-channel transmitter circuitry 118, and example receiver circuitry 120.

In FIG. 1, the programmable circuitry 106 has an input, a first output, and a second output, the primary transmitter circuitry 108 has an input, and an output, the secondary transmitter circuitry 110 has an input and an output, the echo cancellation circuitry 112 has a first input, a second input, and an output, and the receiver circuitry 114 has an input and an output. In FIG. 1, the programmable circuitry 116 has an output and an input, the back-channel transmitter circuitry 118 has an input and an output, and the receiver circuitry 120 has an input and an output.

In FIG. 1, The first output of the programmable circuitry 106 is coupled to the input of the primary transmitter circuitry 108, the second output of the programmable circuitry 106 is coupled to the input of the secondary transmitter circuitry 110, and the input of the programmable circuitry 106 is coupled to the output of the receiver circuitry 114. The output of the primary transmitter circuitry 108 is coupled to the back-channel transmitter circuitry 118 through the communication channel 101. The output of the back-channel transmitter circuitry 118 is also coupled to the first input of the echo cancellation circuitry 112 through the communication channel 101. The input of the secondary transmitter circuitry 110 is coupled to the second output of the programmable circuitry 106, and the output of the secondary transmitter circuitry 110 is coupled to the second input of the echo cancellation circuitry 112. The output of the echo cancellation circuitry 112 is coupled to the input of the receiver circuitry 114.

In FIG. 1, the output of the programmable circuitry 116 is coupled to the first input of the back-channel transmitter circuitry 118, and the input of the programmable circuitry 116 is coupled to the output of the receiver circuitry 120. The input of the receiver circuitry 120 is coupled to the output of the primary transmitter circuitry 108 through the communication channel 101. The output of the back-channel circuitry 118 is coupled to the communication channel 101 In FIG. 1, the first device 102 is a device that transmits data using the front channel of the communication channel 101. Such data is referred to as front channel data. The second device 104 is a device that transmits data using a back-channel of the communication channel 101. Such data is referred to as back-channel data. For example, the first device 102 may be serializer circuitry, and the second device 104 may be deserializer circuitry. In such examples, the front channel data has a data rate greater than the back-channel data to reduce interference. Such multi-directional communications along the communication channel 101 are referred to as full-duplex communications. In some examples, the receiver circuitry 114 is a back-channel receiver, and the receiver circuitry 120 is a forward channel receiver.

In FIG. 1, the echo cancellation circuitry 112 includes example combination circuitry 122, example common mode (CM) variation compensation circuitry 124, and example impedance matching circuitry 126. The combination circuitry 122 has a first input, a second input, a third input, and an output. The CM variation compensation circuitry 124 has an input and an output. The impedance matching circuitry 126 has an input and an output.

The first input of the combination circuitry 122 is coupled to the output of the primary transmitter circuitry 108 and to the output of the back-channel transmitter circuitry 118 through the communication channel 101, the second input of the combination circuitry 122 is coupled to the output of the secondary transmitter circuitry 110, the third input of the combination circuitry 122 is coupled to the output of the CM variation compensation circuitry 124, and the output of the combination circuitry 122 is coupled to the input of the receiver circuitry 114. The input of the CM variation compensation circuitry 124 is coupled to the output of the combination circuitry 122. The input of the impedance matching circuitry 126 is coupled to secondary transmitter circuitry 110 and the output of the impedance matching circuitry 126 is coupled to the second input of the combination circuitry 122.

In an example operation, the back-channel transmitter circuitry 118 receives back-channel data (DATA_{BC}) via one or more data paths from the programmable circuitry 116. The back-channel transmitter circuitry 118 transmits the back-channel data to the first device 102 across the communication channel 101. Similarly, the primary transmitter circuitry 108 receives front channel data via one or more data paths from the programmable circuitry 106. The primary transmitter circuitry 108 transmits the front channel data to the second device 104 across the communication channel 101. Also, the secondary transmitter circuitry 110 provides a replica of the front channel data to the combination circuitry 122. In some examples, the impedance matching circuitry 126 impedance matches the communication channel 101 to reduce echo. Also, the primary transmitter circuitry 108 and the back-channel transmitter circuitry 118 may have different bandwidths. In such examples, the data rates of the transmissions of the front and back-channel data are different to prevent interference. In some examples, the bandwidth of the back-channel transmitter circuitry 118, which transmits the back-channel data, is modified to reduce non-linear gain contributions of the communication channel 101. Advantageously, the primary transmitter circuitry 108 and the back-channel transmitter circuitry 118 support full-duplex data transmissions along the communication channel 101.

In example operations, the second device 104 receives the front channel data after propagating along the communication channel 101. The receiver circuitry 120 produces a serial data stream representing the front channel data responsive to signals from the communication channel 101. In some examples, the receiver circuitry 120 isolates the communication channel 101 from the programmable circuitry 116.

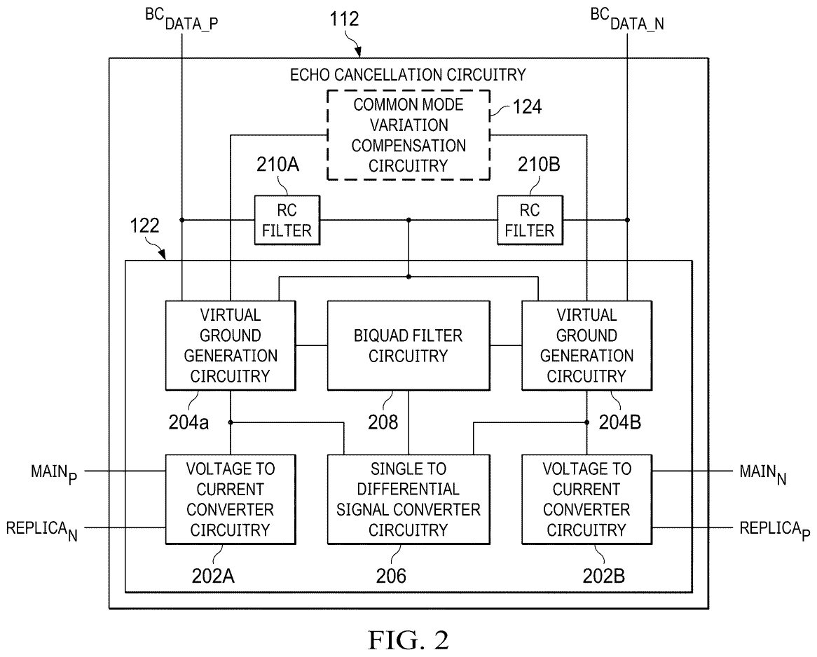

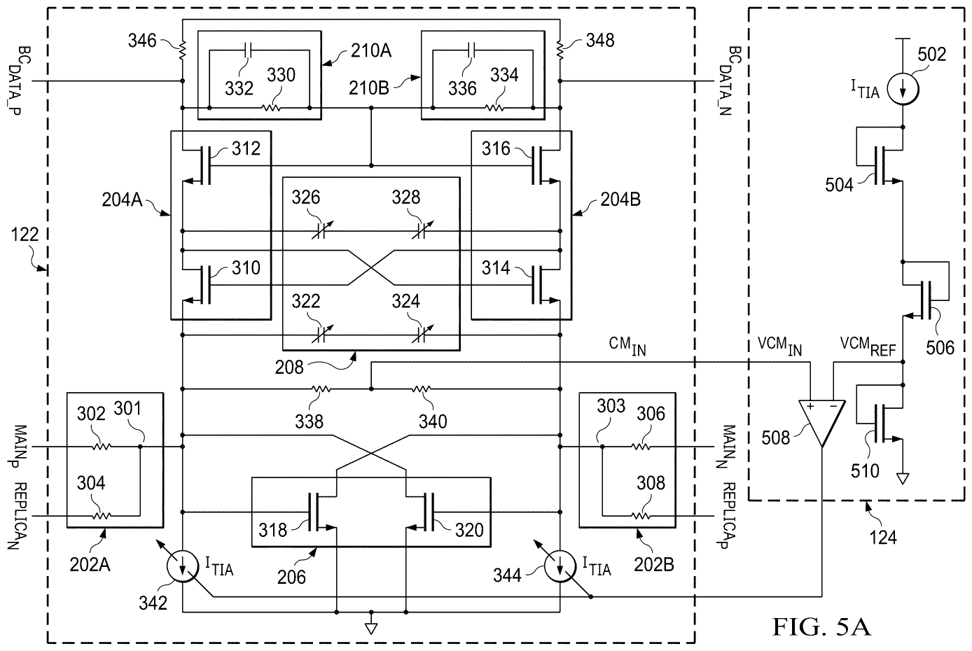

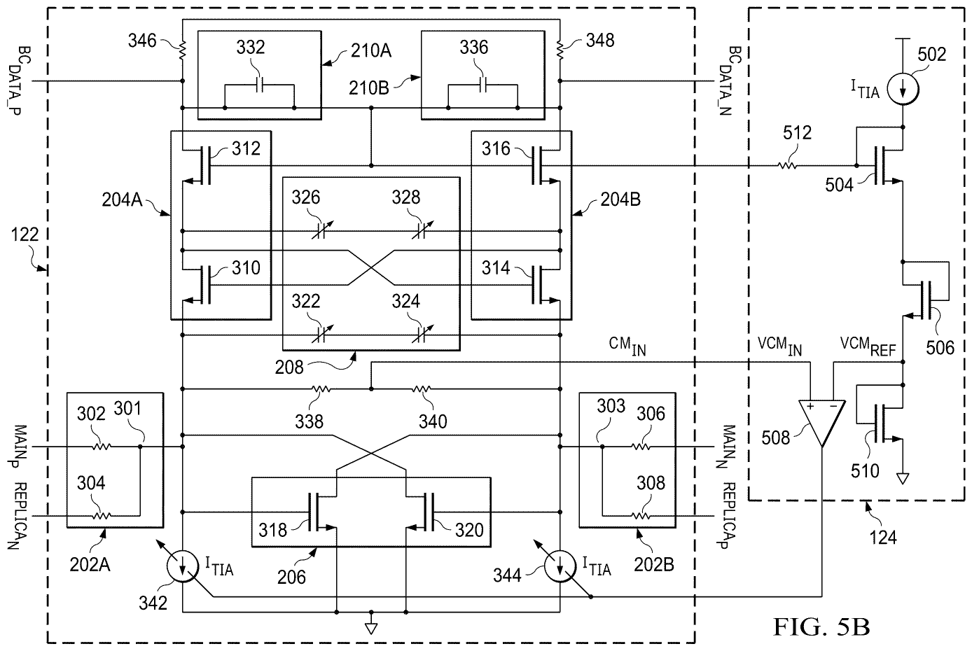

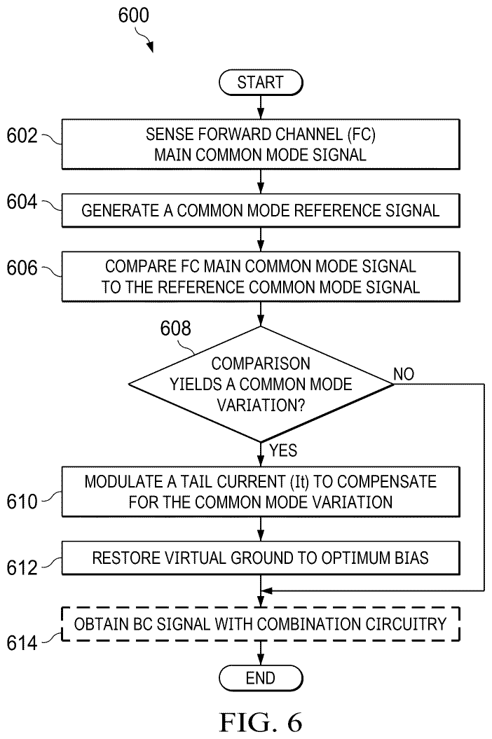

Similarly, the first device 102 receives the back-channel data after propagating along the communication channel 101. The echo cancellation circuitry 112 reduces contributions of the front channel data from signals received by the back-channel receiver circuitry 114. For example, the combination circuitry 122 subtracts the replica front channel data from signals of the communication channel 101. The combination circuitry 122 provides a communication signal representing the back-channel data to the receiver circuitry 114. The combination circuitry 122 is described in further detail below in connection with FIGS. 2-4. The CM variation compensation circuitry 124 sinks bias current variation occurring in the combination circuitry 122 when the common mode voltage of the primary transmitter circuitry 108 varies. The CM variation compensation circuitry 124 provides a stable operating point for the combination circuitry 122. The CM variation compensation circuitry 124 is described in further detail below in connection with FIGS. 5 and 6. The receiver circuitry 114 produces a serial data stream representing the back-channel data responsive to signals from the communication channel 101.

FIG. 2 is a block diagram of an example implementation of the echo cancellation circuitry 112 of FIG. 1. In the implementation of the echo cancellation circuitry 112 illustrated in FIG. 2, the impedance matching circuitry 126 is not included. In FIG. 2, the combination circuitry 122 includes example voltage to current (VC) converter circuitry 202, example virtual ground generation circuitry 204, example single to differential signal converter circuitry 206, example biquad filter circuitry 208, and an example resistor-capacitor (RC) filter 210. In some examples, the VC converter circuitry 202 is a VC converter circuitry pair 202A, 202B for differential input signals, the virtual ground generation circuitry 204 is a virtual ground generation circuitry pair 204A, 204B for differential input signals, and the RC filter 210 is an RC filter pair 210A, 210B for differential input signals.

In FIG. 2, the VC converter circuitry 202A has a first input, a second input, and an output. The VC converter circuitry 202B has a first input, a second input, and an output. The virtual ground generation circuitry 204A has a first input, a second input, a third input, and an output. The virtual ground generation circuitry 204B has a first input, a second input, a third input, and an output. The single to differential signal converter circuitry 206 has a first input, a second input, and an output. The biquad filter circuitry 208 has an input, a first output, and a second output. The RC filter 210A has an input and an output and the RC filter 210B has an input and an output.

In FIG. 2, the first input of the VC converter circuitry 202A is coupled to the output of the primary transmitter circuitry 108 of FIG. 1, the second input of the VC converter circuitry 202A is coupled to the output of the of secondary transmitter circuitry 110, and the output of the VC converter circuitry 202A is coupled to the first input of the virtual ground generation circuitry 204A and to the first input of the single to differential signal converter circuitry 206.

The first input of the VC converter circuitry 202B is coupled to the output of the primary transmitter circuitry 108 of FIG. 1, the second input of the VC converter circuitry 202B is coupled to the output of the of secondary transmitter circuitry 110, the output of the VC converter circuitry 202B is coupled to the first input of the virtual ground generation circuitry 204B and to the second input of the single to differential signal converter circuitry 206.

The second input of the virtual ground generation circuitry 204A is coupled to the first output of the biquad filter circuitry 208, the third input of the virtual ground generation circuitry 204A is coupled to the CM variation compensation circuitry 124 of FIG. 2, and the output of the virtual ground generation circuitry 204A is coupled to the input of the RC filter 210A and to the receiver circuitry 114 of FIG. 1. The output of the RC filter 210A is coupled to a fourth input of the virtual ground generation circuitry 204A.

The second input of the virtual ground generation circuitry 204B is coupled to the second output of the biquad filter circuitry 208, the third input of the virtual ground generation circuitry 204B is coupled to the CM variation compensation circuitry 124 of FIG. 2, and the output of the virtual ground generation circuitry 204B is coupled to the input of the RC filter 210B and to the receiver circuitry 114 of FIG. 1. The output of the RC filter 210B is coupled to a fourth input of the virtual ground generation circuitry 204B.

In FIG. 2, the output of the virtual ground generation circuitry 204A is illustrated to provide positive back-channel data (BC_{DATA_P}) and the output of the virtual ground generation circuitry 204B is illustrated to provide negative back-channel data (BC_{DATA_N}), which is the complementary signal of BC_{DATA_P}. However, the virtual ground generation circuitry 204A may be structured to provide the negative back-channel data while the virtual ground generation circuitry 204B is structured to provide the positive back-channel data.

In example operation the VC converter circuitry 202A receives the main transmission signal (MAIN_{P}) from the primary transmitter circuitry 108 and the replica transmission signal (REPLICA_{N}) from the secondary transmitter circuitry 110. Similarly, the VC converter circuitry 202B receives the main transmission signal (MAIN_{N}) from the primary transmitter circuitry 108 and the replica transmission signal (REPLICA_{P}) from the secondary transmitter circuitry 110. The main transmission signals include back-channel data and front channel data, while the replica transmission signals include the front channel data. The virtual ground generation circuitry 204A generates a virtual ground that ensures the voltage at the first output of the VC converter circuitry 202A does not move when currents are combined at the first output of the VC converter circuitry 202A. Similarly, the virtual ground generation circuitry 204B generates a virtual ground to stabilize an operating point of the virtual ground generation circuitry 204B that ensures the voltage at the first output of the VC converter circuitry 202B does not move.

The VC converter circuitry 202A converts the main transmission signal and replica transmission signal to current signals using two parallel resistors and the virtual ground. The VC converter circuitry 202A combines the current signals to obtain a current representing the back-channel data from the main transmission signal. For example, the negative replica transmission signal (REPLICA_{N}) and the signals corresponding to the front channel data in the positive main transmission signal (MAIN_{P}) cancel out.

Similarly, the VC converter circuitry 202B converts the main transmission signal and replica transmission signal to current signals using two parallel resistors and the virtual ground. The VC converter circuitry 202B combines the current signals to obtain the back-channel data from the main transmission signal. For example, the positive replica transmission signal (REPLICA_{P}) and the signals corresponding to the front channel data in the negative main transmission signal (MAIN_{N}) cancel out.

In the example operation, the single to differential signal converter circuitry 206 operates to convert a single-ended back-channel signal to a differential signal. For example, if the primary transmitter circuitry 108 provides the main transmission signal as one signal whose amplitude is measured relative to ground, the main transmission signal is single-ended. In such an example, the VC converter circuitry 202A or the VC converter circuitry 202B receives the main transmission signal, and the VC converter circuitry 202A or the VC converter circuitry 202B converts the main transmission signal to current and receives current representing the back-channel signal. The single to differential signal converter circuitry 206 converts the back-channel current to a differential back-channel current at the output of the VC converter circuitry 202A or the output of the VC converter circuitry 202B.

In the example operation, the biquad filter circuitry 208 filters the back-channel signals to cancel residual front channel signals included in the back-channel signal. The RC filter 210A receives the filtered positive back-channel signal (BCDATA_P) and removes common mode noise from the positive back-channel signal. Similarly, the RC filter 210B receives the filtered negative back-channel signal (BC_{DATA_N}) and remove common mode noise from the negative back-channel signal. In some examples, the common mode noise rejection improves a precision of the back-channel data provided (e.g., output) by the virtual ground generation circuitry 204A and virtual ground generation circuitry 204B.

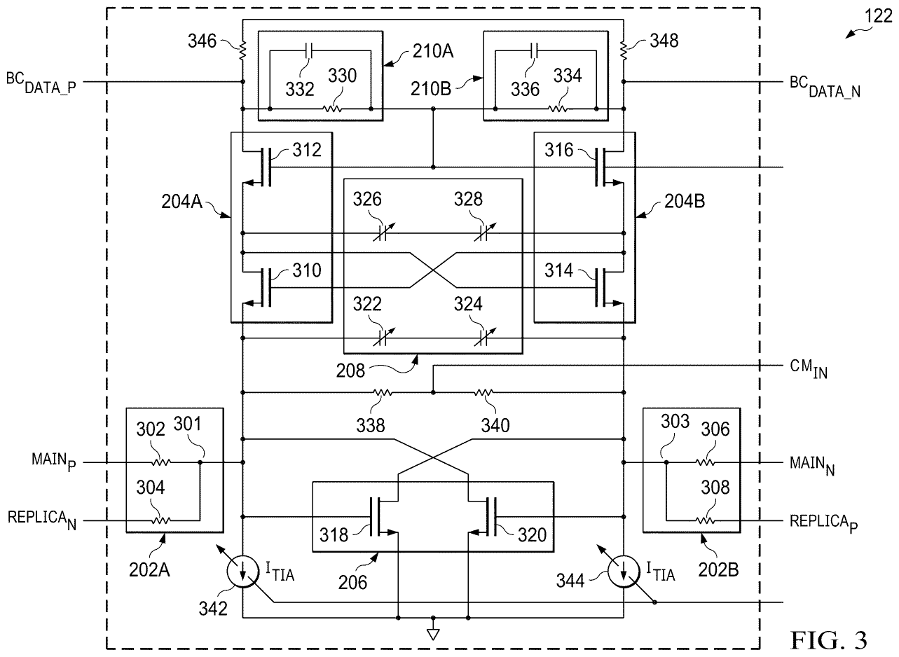

FIG. 3 is a schematic diagram of the example combination circuitry 122 of FIGS. 1 and 2. The combination circuitry 122 of FIG. 3 includes the VC converter circuitry 202A, 202B, the virtual ground generation circuitry 204A, 204B, the single to differential signal converter circuitry 206, the biquad filter circuitry 208, and the resistor-capacitor (RC) filter 210A, 210B. The VC converter circuitry 202A of FIG. 3 includes an example first resistor 302 and an example second resistor 304. The VC converter circuitry 202B of FIG. 3 includes an example third resistor 306 and an example fourth resistor 308. The virtual ground generation circuitry 204A of FIG. 3 includes an example first transistor 310 and an example second transistor 312. The virtual ground generation circuitry 204B of FIG. 3 includes an example third transistor 314 and an example fourth transistor 316. The single to differential signal converter circuitry 206 of FIG. 3 includes an example fifth transistor 318 and an example sixth transistor 320. The biquad filter circuitry 208 of FIG. 3 includes an example first capacitor 322, an example second capacitor 324, an example third capacitor 326, and an example fourth capacitor 328. The RC filter 210A of FIG. 3 includes an example fifth resistor 330 and an example fifth capacitor 332. The RC filter 210B of FIG. 3 includes an example sixth resistor 334 and an example sixth capacitor 336. The combination circuitry 122 of FIG. 3 includes a first load resistor 346 and a second load resistor 348. In some examples, the load resistors 346 and 348 are implemented by transistors.

The VC converter circuitry 202A has a first input, a second input, a first output, and a second output. The VC converter circuitry 202B has a first input, a second input, a first output, and a second output. The first and second inputs of the VC converter circuitry 202A (MAIN_{P}, REPLICA_{N}) and the first and second inputs of the VC converter circuitry 202B (MAIN_{N}, REPLICA_{P}) are coupled to the output of the primary transmitter circuitry 108 of FIG. 1 and secondary transmitter circuitry 110 of FIG. 1, respectively. In some examples, the primary transmitter circuitry 108 and the secondary transmitter circuitry 110 provide a differential pair of signals at the first and second inputs of the VC converter circuitry 202A, 202B.

The first resistor 302 has a first terminal and a second terminal. The second resistor 304 has a first terminal and a second terminal. The first terminal of the first resistor 302 is coupled to the first input of the VC converter circuitry 202A, which is coupled to the output of the communication channel 101 and receives the positive main transmission signal MAIN_{P}, and the second terminal of the first resistor 302 is coupled to the second terminal of the second resistor 304. The first terminal of the second resistor 304 is coupled to the second input of the VC converter circuitry 202A, which is coupled to the output of the secondary transmitter circuitry 110 and receives the negative replica transmission signal REPLICA_{N}. In some examples, the node at which the second terminal of the first resistor 302 and the second terminal of the second resistor 304 are coupled is referred to as a first summing node 301.

The third resistor 306 has a first terminal and a second terminal. The fourth resistor 308 has a first terminal and a second terminal. The first terminal of the third resistor 306 is coupled to the first input of the VC converter circuitry 202B, which is coupled to the output of the communication channel 101 and receives the negative main transmission signal MAIN_{N}, and the second terminal of the third resistor 306 is coupled to the second terminal of the fourth resistor 308. The first terminal of the fourth resistor 308 is coupled to the second input of the VC converter circuitry 202B, which is coupled to the output of the secondary transmitter circuitry 110 and receives the positive replica transmission signal REPLICA_{P}. In some examples, the node at which the second terminal of the third resistor 306 and the second terminal of the fourth resistor 308 are coupled is referred to as a second summing node 303.

The virtual ground generation circuitry 204A has an output. The first transistor 310 has a first terminal, a second terminal, and a control terminal. The second transistor 312 has a first terminal, a second terminal, and a control terminal. The second terminal of the first transistor 310 is coupled to the second terminals of the first resistor 302 and the second resistor 304. The first terminal of the first transistor 310 is coupled to the second terminal of the second transistor 312. The first terminal of the second transistor 312 is coupled to the output of the virtual ground generation circuitry 204A. For example, the first terminal of the second transistor 310 is coupled to the receiver circuitry 114 of FIG. 1 and provides the back-channel data to the receiver circuitry 114. In this example, the transistor 310 and 312 are cascoded. The cascode transistor 312, along with transistor 310, is to create the virtual ground at the summing node 301.

The virtual ground generation circuitry 204B has an output. The third transistor 314 has a first terminal, a second terminal, and a control terminal. The fourth transistor 316 has a first terminal, a second terminal, and a control terminal. The second terminal of the third transistor 314 is coupled to the second terminals of the third resistor 306 and the fourth resistor 308. The first terminal of the third transistor 314 is coupled to the second terminal of the fourth transistor 316. The first terminal of the fourth transistor 316 is coupled to the output of the virtual ground generation circuitry 204B. For example, the first terminal of the fourth transistor 316 is coupled to the receiver circuitry 114 of FIG. 1 and provides the back-channel data to the receiver circuitry 114. In this example, the transistor 314 and 316 are cascoded. The cascode transistor 316, along with transistor 314 is to create the virtual ground at the summing node 303.

The control terminal of the first transistor 310 is coupled to the first terminal of the third transistor 314 and second terminal of the fourth transistors 316. The control terminal of the third transistor 314 is coupled to the first terminal of the first transistor 310 and the second terminal of the second transistor 312. The control terminal of the second transistor 312 is coupled to the control terminal of the fourth transistor 316.

In some examples, the first transistor 310, the second transistor 312, the third transistor 314, and the fourth transistor 316 form the transimpedance amplifier. A transimpedance amplifier (TIA) is used in conjunction with the load resistors 346 and 348 to convert an input current (e.g., current at the summing nodes 301, 303) to an output volage (BC_{DATA_P}, BC_{DATA_N}), without the high impedance that a large resistor may present when converting current to voltage. The cross-coupling between transistors 310 and 314 creates an effectual negative resistance, which, in series with transistors 312 and 316, creates a virtual ground. For example, the first terminal of transistor 314 causes transistor 310 to be a negative resistance and the first terminal of transistor 310 causes transistor 314 to be a positive resistance. The transistor 312, which is coupled in series with transistor 310, is a positive resistance, making the resistance at the summing node 301 zero (e.g., −1 Ohm+1 Ohm=0 Ohms). Similarly, the transistor 316, which is coupled in series with transistor 314, is a negative resistance, making the resistance at the summing node 303 zero (e.g., 1 Ohm+−1 Ohm=0 Ohms) Essentially, the virtual ground creates a low impedance at the summing nodes 301, 303 so that voltage at those nodes does not change with signal current.

The fifth transistor 318 has a first terminal, a second terminal, and a control terminal. The sixth transistor 320 has a first terminal, a second terminal, and a control terminal. The first terminal of the fifth transistor 318 is coupled to the second terminals of the third and fourth resistors 306, 308. The second terminal of the fifth transistor 318 is coupled to a ground potential. The control terminal of the fifth transistor 318 is coupled to the second terminals of the first resistor 302 and second resistor 304 and to the first terminal of the sixth transistor 320. The first terminal of the sixth transistor 320 is coupled to the second terminals of the first and second resistor 302, 304. The second terminal of the sixth transistor 320 is coupled to the ground potential. The control terminal of the sixth transistor 320 is coupled to second terminals of the third and fourth resistors 306, 308 and to the first terminal of the fifth transistor 318.

The first capacitor 322 has a first terminal and a second terminal. The second capacitor 324 has a first terminal and a second terminal. The third capacitor 326 has a first terminal and a second terminal. The fourth capacitor 328 has a first terminal and a second terminal. The first terminal of the first capacitor 322 is coupled to the second terminal of the first transistor 310, the second terminal of the first resistor 302, and the second terminal of the second resistor 304. The first terminal of the second capacitor 324 is coupled to the second terminal of the first capacitor 322. The second terminal of the second capacitor 324 is coupled to the second terminal of the third transistor 314, the second terminal of the third resistor 306, and the second terminal of the fourth resistor 308. The first terminal of the third capacitor 326 is coupled to the second terminal of the second transistor 312, the control terminal of the third transistor 314, and the first terminal of the first transistor 310. The first terminal of the fourth capacitor 328 is coupled to the second terminal of the third capacitor 326. The second terminal of the fourth capacitor 328 is coupled to the second terminal of the fourth transistor 316, the control terminal of the first transistor 310, and the first terminal of the third transistor 314.

The fifth resistor 330 has a first terminal and a second terminal. The fifth capacitor 332 has a first terminal and a second terminal. The sixth resistor 334 has a first terminal and a second terminal. The sixth capacitor 336 has a first terminal and a second terminal. The first terminal of the fifth resistor 330 is coupled to the first terminal of the second transistor 312 and to the output of the virtual ground generation circuitry 204A. The second terminal of the fifth resistor 330 is coupled to the control terminal of the second transistor 312 and to the control terminal of the fourth transistor 316. The first terminal of the fifth capacitor 332 is coupled to the first terminal of the fifth resistor 330, to the first terminal of the second transistor 312, and to the output of the virtual ground generation circuitry 204A. The second terminal of the fifth capacitor 332 is coupled to the second terminal of the fifth resistor 330, to the control terminal of the second transistor 312 and to the control terminal of the fourth transistor 316.

The second terminal of the sixth resistor 334 is coupled to the first terminal of the fourth transistor 316 and to the output of the virtual ground generation circuitry 204B. The first terminal of the sixth resistor 334 is coupled to the control terminal of the second transistor 312 and to the control terminal of the fourth transistor 316. The second terminal of the sixth capacitor 336 is coupled to the second terminal of the sixth resistor 334, to the first terminal of the fourth transistor 316, and to the output of the virtual ground generation circuitry 204B. The first terminal of the sixth capacitor 336 is coupled to the first terminal of the sixth resistor 334, to the control terminal of the second transistor 312 and to the control terminal of the fourth transistor 316.

In some examples, the combination circuitry 122 of FIG. 3 includes a seventh resistor 338 and an eighth resistor 340. The seventh resistor 338 and the eighth resistor 340 averages the voltages at node 301 and 303 to generate a common mode signal (CM_{IN}) representing a common mode voltage of the primary transmitter circuitry 108 of FIG. 1. The common mode voltage signal (CM_{IN}) is provided to the common mode variation compensation circuitry 124 of FIGS. 1 and 2.

The seventh resistor 338 has a first terminal and a second terminal. The eighth resistor 340 has a first terminal and a second terminal. The first terminal of the seventh resistor 338 is coupled to the second terminal of the first resistor 302, the second terminal of the second resistor 304 and the second terminal of the first transistor 310. The second terminal of the seventh resistor 338 is coupled to the first terminal of the eighth resistor 340. The second terminal of the eighth resistor 340 is coupled to the second terminal of the third resistor 306, the second terminal of the of the fourth resistor 308, and to the second terminal of the third transistor 314. The second terminal of the seventh resistor 338 and the first terminal of the eighth resistor 340 is coupled to an input of the common mode variation compensation circuitry 124.

In some examples, the combination circuitry 122 of FIG. 3 includes a first current source 342 and a second current source 344. The first and second current sources 342 and 344 are tail current sources. A tail current source supplies a constant current to the first transistor 310, the second transistor 312, the third transistor 314, and the fourth transistor 316. In some examples, the first current source 342 and the second current source 344 are implemented by resistors or transistors.

The first current source 342 is coupled to the second terminals of the first and second resistor 302, 304, to the second terminal of the first transistor 310, and to an output of the CM variation compensation circuitry 124. The second current source 344 is coupled to the second terminals of the third and fourth resistors 306, 308, to the second terminal of the third transistor 314, and to the output of the CM variation compensation circuitry 124. The CM variation compensation circuitry 124 is described in further detail below in connection with FIGS. 5 and 6.

In the example of FIG. 3, the transistors 310, 312, 314, 316, 318, 320 are n-channel metal-oxide semiconductor field-effect transistors (MOSFETs). Alternatively, the transistors 310, 312, 314, 316, 318, 320 may be n-channel field-effect transistors (FETs), n-channel insulated-gate bipolar transistors (IGBTs), n-channel junction field effect transistors (JFETs), NPN bipolar junction transistors (BJTs) or, with slight modifications, p-type equivalent devices. The transistors 310, 312, 314, 316, 318, 320 may be depletion mode devices, drain-extended devices, enhancement mode devices, natural transistors or other type of device structure transistors. Furthermore, the transistors 310, 312, 314, 316, 318, 320 may be implemented in/over a silicon substrate (Si), a silicon carbide substrate (SiC), a gallium nitride substrate (GaN) or a gallium arsenide substrate (GaAs).

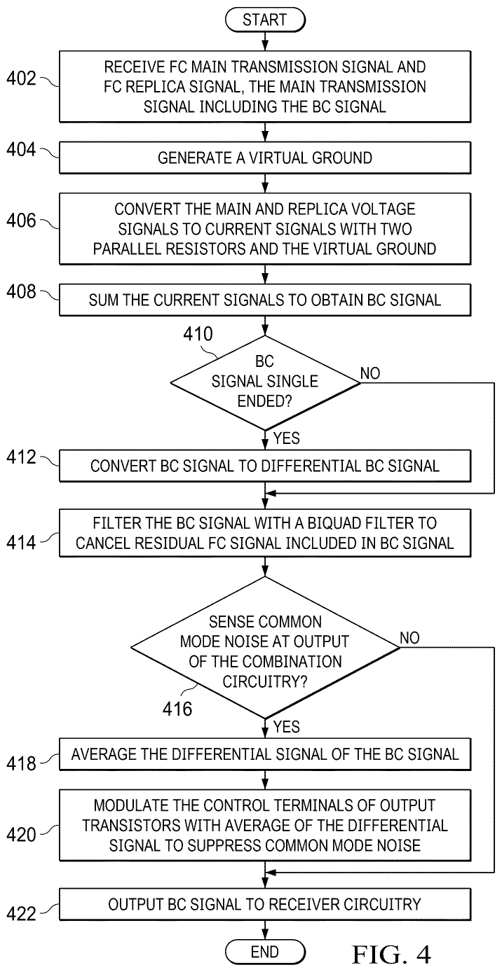

FIG. 4 is a flowchart representative of example machine-readable instructions or example operations 400 that may be at least one of executed, instantiated, or performed using an example implementation of the combination circuitry 122 of FIGS. 1, 2, 3. The example operations 400 of FIG. 4 begin at block 402 at which the voltage to current converter circuitry 202A, 202B receives signals for summing. In example operations, the VC converter circuitry 202A, 202B receives a main transmission signal (MAIN_{P}, MAIN_{N}) from the communication channel 101 of FIG. 1 and a replica transmission signal (REPLICA_{P}, REPLICA_{N}) from the secondary transmitter circuitry 110 of FIG. 1. The main transmission signals are a pair of differential signals representing a serial data stream including front channel data and back-channel data from the communication channel 101 of FIG. 1. The replica transmission signals are a pair of differential signals representing a serial data stream including the front channel data.

At block 404, the virtual ground generation circuitry 204A, 204B generates a virtual ground. The first transistor 310 in series with the second transistor 312 creates a virtual ground at the second terminal of the first transistor 310 because the control terminal of the first transistor 310 is coupled to the first terminal of the third transistor 314 and the second terminal of the fourth transistor 316. Coupling the control terminal of the first transistor 310 to the first terminal of the third transistor 314 and the second terminal of the fourth transistor 316 provides an inverted active feedback loop that creates the virtual ground at the inverting input of the TIA. In the example of FIG. 3, the third transistor 314 in series with the fourth transistor 316 creates a virtual ground at the second terminal of the third transistor 314 because the control terminal of the third transistor 314 is coupled to the first terminal of the first transistor 310 and the second terminal of the second transistor 312.

At block 406, the VC converter circuitry 202A, 202B convert the main and replica voltage signals to current signals with two parallel resistors 302, 304 and 306, 308 and the virtual ground. For example, the first resistor 302 determines how much current of the positive main transmission signal (MAIN_{P}) flows into combination circuitry 122, the second resistor 304 determines how much current of the negative replica transmission signal (REPLICA_{N}) flows into combination circuitry 122, the third resistor 306 determines how much current of the negative main transmission signal (MAIN_{N}) flows into combination circuitry 122, and the fourth transistor 308 determines how much current of the positive replica transmission signal (REPLICA_{P}) flows into combination circuitry 122.

At block 408, the VC converter circuitry 202A, 202B sums the current signals to obtain the back-channel signal. For example, current representing the positive main transmission signal (MAIN_{P}) is combined at the first summing node 301 with current representing the negative replica transmission signal (REPLICA_{N}). Any positive current corresponding to front channel data in the main transmission signal is cancelled out with the complementary front channel data represented by the negative replica transmission signal. The remaining current, representing positive back-channel data, flows through the first summing node 301. Similarly, current representing the negative main transmission signal (MAIN_{N}) is combined at the second summing node 303 with current representing the positive replica transmission signal (REPLICA_{P}). Any negative current corresponding to front channel data in the main transmission signal is cancelled out with the complementary front channel data represented by the positive replica transmission signal. The remaining current, representing negative back-channel data, flows through the second summing node 303.

At block 410, the single to differential signal converter circuitry 206 determines whether the back-channel signal is single-ended. For example, the single to differential signal converter circuitry 206 determines whether the main transmission signal is a differential signal based on whether one or both VC converter circuitry 202A, 202B received a main transmission signal. As described above, the main transmission signals include a combination of back-channel data and front channel data. In some examples, when VC converter circuitry 202A receives a main transmission signal and VC converter circuitry 202B does not, then the single to differential signal converter circuitry 206 determines that the back-channel signal is single-ended. When both VC converter circuits 202A, 202B receive main transmission signals, the single to differential signal converter circuitry 206 determines that the back-channel signal is differential.

At block 412, when the single to differential signal converter circuitry 206 determines that the back-channel signal is single-ended (e.g., block 410 returns a value YES), the single to differential signal converter circuitry 206 converts the back-channel signal to a differential back-channel signal. For example, the fifth transistor 318 and the sixth transistor 320 operate together to generate complementary signals at the first terminals of transistors 318 and 320 based on an input signal from either the first summing node 301 or the second summing node 303. In an example where the back-channel signal is single-ended, the voltage at the first summing node 301 or the second summing node 303 can move, as the virtual ground generation may not be perfect. In such an example, the transistors 318 and 320 operate to inject inverted current signals into the opposite input of TIA (e.g., into the first terminals of transistors 310 and 314), which assists in generating a better virtual ground by making the inputs to TIA differential.

At block 414, if the single to differential signal converter circuitry 206 determines that the back-channel signal is differential (e.g., block 410 returns a value NO) or when the single to differential signal converter circuitry 206 converts the single-ended back-channel signal to a differential back-channel signal, the biquad filter circuitry 208 filters the back-channel signal to cancel residual signals included in the back-channel signal. For example, the capacitors 322, 324, 326, 328 block current corresponding to frequencies outside the bandwidth of the back-channel data. In some examples, values of the capacitors 322, 324, 326, 328 are tuned in order to set the bandwidth of the biquad filter circuitry 208. For example, capacitors 322, 324, 326, and 328 are tunable and tuned with a certain value of capacitance to support different frequencies of the back-channel signal. The biquad filter circuitry 208 cuts off the frequency beyond the set bandwidth at a steep rate. For example, a steep roll off in frequency is when the signal attenuation rapidly increases as the frequency moves away from the passband (e.g., the tuned bandwidth), meaning the biquad filter circuitry 208 transitions quickly from passing frequencies to blocking frequencies, resulting in a sharp decline in signal strength within a narrow frequency range. For example, a 40 dB roll off compared to a 20 dB roll off of a different type of filter (e.g., RC filter). In some examples, the frequencies being blocked by the biquad filter circuitry 208 are referred to as noise (e.g., echo from the front channel).

At block 416, the RC filters 210A, 210B sense whether common mode noise is at the output of the combination circuitry 122. In some examples, common mode noise is the result of the main transmission signals (MAIN_{P}, MAIN_{N}) not being identically differential. For example, when the communication channel 101 (FIG. 1) is implemented by a coaxial cable, the main transmission signal is single ended and the MAIN_{N} signal may have a different peak-to-peak than the MAIN_{P} signal. As a result, common mode noise is typically sensed at the output of the combination circuitry 122. The RC filters 210A, 210B and, more specifically, the resistors 330, 334 and capacitors 332, 336, make the back-channel signal differential to remove the common mode noise.

At block 418, the RC filters 210A, 210B average the differential signal of the back-channel signal. For example, the feedback resistors 330, 334 can determine the average voltage of the differential outputs (BC_{DATA_P}, BC_{DATA_N}). In some examples, the resistors 330, 334 have equal resistance values, because two equal resistors connected to two voltage sources provide the average of the two voltage sources at their junction (e.g., at the location where the two resistors 330, 334 are coupled).

At block 420, the RC filters 210A, 210B modulate the control terminals of transistors 312 and 316 with the average of the differential signal to suppress the common mode noise. For example, the junction of the resistors 330, 334 is coupled to the control terminal of the second transistor 312 and the control terminal of the fourth transistor 316. The average voltage of the output signal BC_{DATA_P} at the first terminal of transistor 312 and of the output signal BC_{DATA_N} at the first terminal of transistor 316 is provided as an input to the control terminals of transistors 312, 316. At low frequencies, the resistors 330, 334 average the differential outputs and provide the average of the differential outputs to the control terminals of transistors 312 and 316 to minimize common mode noise. At higher frequencies, the capacitors 332, 336 average the differential outputs to control the control terminals of transistor 312 and 316 to minimize common mode noise.

At block 422, the virtual ground generation circuitry 204A, 204B outputs the back-channel signal to receiver circuitry 114 of FIG. 1. For example, the voltage of the back-channel signal is generated based on the current, through the first transistor 310 and the second transistor 312, flowing into the load resistor 346 at the first output (BC_{DATA_P}) of the combination circuitry 122, where common mode noise and frequencies outside the bandwidth of the back-channel data are removed. Similarly, the voltage of the back-channel signal is generated based on the current, through the third transistor 314 and the fourth transistor 316, flowing into the load resistor 348 at the second output (BC_{DATA_N}) of the combination circuitry 122, where common mode noise and frequencies outside the bandwidth of the back-channel data are removed.

Example methods are described with reference to the flowchart illustrated in FIG. 4. However, many other methods of implementing the combination circuitry 122 of FIGS. 1, 2, and 3 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIGS. 5A and 5B are schematic diagrams of example implementations of the echo cancellation circuitry 112 of FIGS. 1 and 2. FIG. 5A illustrates a first implementation of the echo cancellation circuitry 112 with the example combination circuitry 122 of FIGS. 1-3 and the example common mode variation compensation circuitry 124 of FIGS. 1 and 2. FIG. 5B illustrates a second implementation of the echo cancellation circuitry 112 with the example combination circuitry 122 of FIGS. 1-3 and the example common mode variation compensation circuitry 124 of FIGS. 1 and 2.

In FIG. 5A, the combination circuitry 122 is or is implemented by the combination circuitry 122 of FIG. 3. The CM variation compensation circuitry 124 may be added to and/or implemented in the echo cancellation circuitry 112 to reduce or eliminate changes in bias current of the transistors 310, 312, 314, 316 of the combination circuitry 122 resulting from a variation of common mode voltage of the primary transmitter circuitry 108 of FIG. 1. In some examples, the bias current of transistors 310, 312, 314, 316 is set by the first and second current sources 342 and 344 of the combination circuitry 122 of FIG. 3. Therefore, the CM variation compensation circuitry 124 restores the first and second current sources 342, 344 to the bias current when the bias current is affected by changes in common mode voltage.

The CM variation compensation circuitry 124 includes an example third current source 502, an example seventh transistor 504, an example eighth transistor 506, an example comparator 508, and an example ninth transistor 510.

The third current source 502 has an input and an output. The input of the current source 502 is coupled to a supply voltage of the echo cancellation circuitry 112. The seventh transistor 504 has a first terminal, a second terminal, and a control terminal. The first terminal of the transistor 504 is coupled to the output of the current source 502. The control terminal of the transistor 504 is coupled to the first terminal of transistor 504.

The eighth transistor 506 has a first terminal, a second terminal, and a control terminal. The comparator 508 has a first input, a second input, and an output. The first terminal of the transistor 506 is coupled to the second terminal of the transistor 504 and to the control terminal of transistor 506. For example, the control terminal of transistor 506 is tied to the first terminal of transistor 506 and to the second terminal of transistor 504. The second terminal of transistor 506 is coupled to the second input of the comparator 508. In some examples, the second input of the comparator 508 is an inverting input. The first input of the comparator 508 is coupled to the second terminal of resistor 338 and to the first terminal of the resistor 340 of the combination circuitry 122. In some examples, the first input of the comparator 508 is a non-inverting input. The output of the comparator 508 is coupled to an input of the first current source 342 and an input of the second current source 344 of the combination circuitry 122.

The ninth transistor 510 includes a first terminal, a second terminal, and a control terminal. The first terminal of the transistor 510 is coupled to the second terminal of transistor 506 and to the second input of comparator 508. The control terminal of transistor 510 is coupled to the first terminal of transistor 510. For example, the control terminal of transistor 510 is tied to the first terminal of transistor 510. The second terminal of transistor 510 is coupled to ground.

In the example of FIG. 5A, the transistors 504, 506, and 510 are n-channel metal-oxide semiconductor field-effect transistors (MOSFETs). Alternatively, the transistors 504, 506, and 510 may be n-channel field-effect transistors (FETs), n-channel insulated-gate bipolar transistors (IGBTs), n-channel junction field effect transistors (JFETs), NPN bipolar junction transistors (BJTs) or, with slight modifications, p-type equivalent devices. The transistors 504, 506, and 510 may be depletion mode devices, drain-extended devices, enhancement mode devices, natural transistors or other type of device structure transistors. Furthermore, the transistors 504, 506, and 510 may be implemented in/over a silicon substrate (Si), a silicon carbide substrate (SiC), a gallium nitride substrate (GaN) or a gallium arsenide substrate (GaAs).

In the example of FIG. 5A, transistor 504 matches transistors 312 and 316 of the combination circuitry 122. For example, transistor 504 is designed and fabricated in the same or comparable manner as the transistors 312, 316. Transistor 504 matches transistors 312 and 316 to replicate the current flow through transistors 312 and 316 when proper (e.g., accurate, not effected by common mode voltage variation, etc.) bias current is supplied to the transistors 312, 316. Transistor 504 matches transistors 312 and 316 to replicate the characteristics of the transimpedance amplifiers (e.g., transistors 310, 312, 314, 316), such as the ratio of transconductance (gm) and drain current (Id) and the ratio of drain current (Id) and channel width (W).

In the example of FIG. 5A, transistor 506 matches transistors 310 and 314 of the combination circuitry 122. For example, transistor 506 is designed and fabricated in the same or comparable manner as the transistors 310, 314. Transistor 506 matches transistors 310 and 314 to replicate the characteristics of the transimpedance amplifiers (e.g., transistors 310, 312, 314, 316), such as the ratio of transconductance (gm) and drain current (Id) and the ratio of drain current (Id) and channel width (W).

In the example of FIG. 5A, transistor 510 matches transistors 318 and 320 of the combination circuitry 122. For example, transistor 510 is designed and fabricated in the same or comparable manner as the transistors 318, 320. Transistor 510 matches transistors 318 and 320 to replicate the characteristics of the transistors 318 and 320, such as the ratio of transconductance (gm) and drain current (Id) and the ratio of drain current (Id) and channel width (W).

As mentioned above, the CM variation compensation circuitry 124 restores the first and second current sources 342, 344 to the bias current when the bias current is affected by changes in common mode voltage. To restore the currents of the first and second current sources 342 and 344, and maintain consist bias current, the CM variation compensation circuitry 124 provides process tracking, which improves an overall operation of the combination circuitry 122. For example, matching the transistors 310 and 314 with transistor 506, matching transistors 312 and 316 with 504, and matching transistors 318 and 320 with transistor 510 reduces the variation in transconductance (gm) of transistors 310, 312, 314, 316, 318, and 320 and, thus, improves consistency across transistors 310, 312, 314, 316, 318, and 320. In turn, echo cancellation of the back-channel data is improved.

FIG. 5B is the second implementation of the echo cancellation circuitry 112 with the combination circuitry 122 and the CM variation compensation circuitry 124. Similar to the first implementation, the second implementation illustrated in FIG. 5B is to restore the first and second current sources 342, 344 to the bias current when the bias current is affected by changes in common mode voltage and, thus, improve an operation of transistors 310, 312, 314, 316, 318, and 320. The difference in the second implementation illustrated in FIG. 5B is that a resistor 512 is added to directly couple CM variation combination circuitry 124 to the control terminals of transistors 312 and 316. Directly coupling the CM variation compensation circuitry 124 to the control terminals of transistors 312 and 316 sets the biasing voltage for transistors 312 and 316. For example, the transistors 504, 506, and 510, along with resistor 512 set the biasing voltage of transistors 312 and 316. Biasing the transistors 312 and 316 causes the current of current source 502 to match the currents of current sources 342 and 344. Matching the currents of 342 and 344 with the current of current source 502 improves the process tracking.

In FIG. 5B, the combination circuitry 122 does not include the resistors 330 and 334. The resistors 330 and 334 are removed in the second implementation of the echo cancellation circuitry 122 because resistor 512 provides the DC biasing of transistors 312 and 316 rather than the resistors 330 and 334 of FIG. 5A.

In some examples, the echo cancellation circuitry 112 is configured with the first implementation illustrated in FIG. 5A. In alternative examples, the echo cancellation circuitry 112 is configured with the second implementation of FIG. 5B.

FIG. 6 is a flowchart representative of example machine-readable instructions or example operations 600 that may be at least one of executed, instantiated, or performed using an example implementation of the CM variation compensation circuitry 124 of FIGS. 1, 2, and 4. The example operations 600 of FIG. 6 begin at block 602 at which the comparator 508 of FIG. 5A or FIG. 5B senses the forward channel main common mode signal indirectly through the common mode of the TIA input, which is a function of the common mode of the forward channel signals (e.g., MAIN_{P}, MAIN_{N}, REPLICA_{P}, REPLICA_{N}). For example, resistors 338 and 340 of FIG. 3 provide the common mode voltage (V_{CMIN}) of the voltages at the second terminals of the first transistor 310 and third transistor 314 to the first input of the comparator 508. For example, the resistors 338 and 340 average the voltages at the second terminals of the transistor 310 and transistor 314 to determine the common mode voltage (V_{CMIN}). In some examples, the common mode voltage V_{CMIN} is the common mode voltage of the combination circuitry 122, which may be affected by variations of primary transmitter circuitry 108 and secondary transmitter circuitry 110 common mode voltage (V_{CMDRV}) and variations in the bias current of the TIA (ΔI_{DRV}). For example, the current of the transimpedance amplifier (e.g., the current through transistors 310-316) is equal to I_{TIA}=I_{TIA}−ΔI_{DRV}.

At block 604, transistors 504, 506, and 510 generate a common mode reference signal (V_{CMREF}). The common mode reference signal provided by transistors 504 and 506 does not have bias current variation (ΔI_{DRV}) from changes in common mode voltage (V_{CMDRV}) of the primary transmitter circuitry 108 and secondary transmitter circuitry 110. As such, the transistors 504, 506, and 510, along with the current source 502, generate ideal common mode voltage of the transimpedance amplifier.

At block 606, the comparator 508 compares the common mode of the TIA input signal (e.g., the signal at the second terminals of transistor 310 and 314) to the reference common mode signal. For example, the signal V_{CMIN} at the first input of the comparator 508 is compared to the signal V_{CMREF} at the second input of the comparator 508.

At block 608, the comparator 508 determines whether the comparison yields a common mode variation. For example, the comparator 508 adjusts the signal provided at the output when the signal V_{CMIN} at the first input of the comparator 508 is different than the signal V_{CMREF} and does not adjust the signal provided at the output when the signals V_{CMIN} and V_{CMREF} are equal or approximately equal. As such, when V_{CMIN} and V_{CMREF} are not equal, a common mode variation occurs or is occurring within the combination circuitry 122.

At block 610, when the comparator 508 adjusts the signal provided at the output based on V_{CMIN} and V_{CMREF} not having equal or approximately equal values (e.g., block 608 returns a value YES), the comparator 508 modulates a tail current (It) to compensate for the common mode variation. For example, the comparator 508 adjusts the signal at the output to make the common mode voltage V_{CMIN} match the common mode reference voltage V_{CMREF}. Therefore, the comparator 508 increases the signal at the output when V_{CMIN} is greater than V_{CMREF} and decreases the signal at the output when V_{CMIN} is less than V_{CMREF}. The signal provided at the output of the comparator 508 is injected into the first current source 342 and the second current source 344.

Advantageously, at block 612, the first current source 342 and second current source 344 restore the virtual ground to optimum bias. For example, the bias current variation (ΔI_{DRV}) affects the bias currents of 310-316 and, thus, results in common mode variation of the inputs to the TIA, moving the operating points of transistors 310-316 away from ideal bias currents. When the operating points of transistors 310-316 moves away from ideal bias currents, there is poor virtual ground generation and, thus, the voltage at the summing nodes 301, 303 could move, thereby affecting the value of the current representing the back-channel data. Also, when the operating points of transistors 310-316 move away from ideal bias currents, a bandwidth of the biquad filtering affects a performance of echo rejection. By injecting the first and second current sources 342, 344 with current based on the difference between V_{CMIN} and V_{CMREF}, the operating points of transistors 310-316 are restored and, thus, virtual ground and bandwidth of the biquad filtering is restored.

At block 614, the combination circuitry 122 continues to receive the back-channel signal. For example, when the comparator 508 restores virtual ground and bandwidth of the biquad filtering in the combination circuitry 122, the combination circuitry 122 is able to reject echo from the primary transmitter circuitry 108 and receive a clean back-channel signal.

Example methods are described with reference to the flowchart illustrated in FIG. 6. However, many other methods of implementing the CM variation compensation circuitry 124 of FIGS. 1, 2, and 5 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

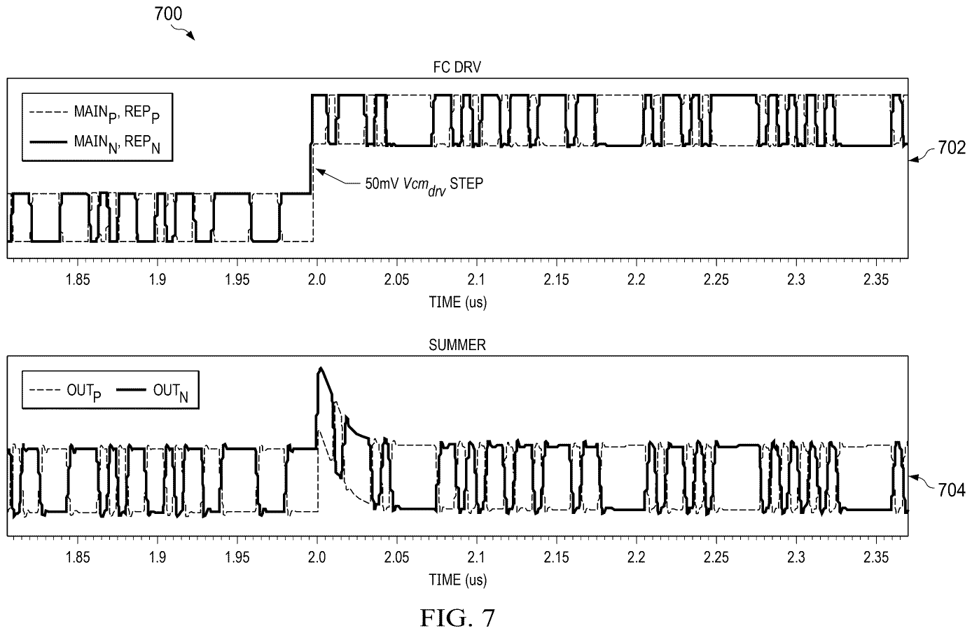

FIG. 7 is a plot 700 of example common mode voltages of the primary transmitter circuitry 108 and the secondary transmitter circuitry 110 of FIG. 1 and the common mode voltage of the combination circuitry 122 of FIGS. 1, 2, 3, and 5 during operation of the CM variation compensation circuitry 124 of FIGS. 1, 2, and 5. The example plot 700 of FIG. 7 includes an input signal 702 and an output signal 704.

The input signal 702 illustrates common mode voltage provided by the primary transmitter circuitry 108 and secondary transmitter circuitry 110 of FIG. 1. The common mode voltage corresponds to the common mode of the differential forward channel signals (MAIN_{P}, MAIN_{N}) over time. In the example of FIG. 7, the common mode voltage has a 50 mV step (e.g., voltage increase).

The output signal 704 illustrates common mode voltage signal provided by the combination circuitry 122 in response to the common mode voltage of the input signal 702. The common mode voltage signal, illustrated by output signal 704, corresponds to the common mode of the differential outputs signals BC_{DATA_P}, BC_{DATA_N} over time. In the example of FIG. 7, the output signal 704 (e.g., the common mode voltage of the differential outputs signals BC_{DATA_P}, BC_{DATA_N}) steps up in response to the 50 mV step of the primary transmitter circuitry 108. Advantageously, the CM variation compensation circuitry 124 corrects the voltage step of the common mode of the output signal 704 to reduce or eliminate changes in bias current of the combination circuitry 122. As shown in the output signal 704, the common mode voltage quickly (e.g., less than 0.05 microseconds) drops back down to the original output common mode voltage from the spike in common mode voltage of the input signal 702.

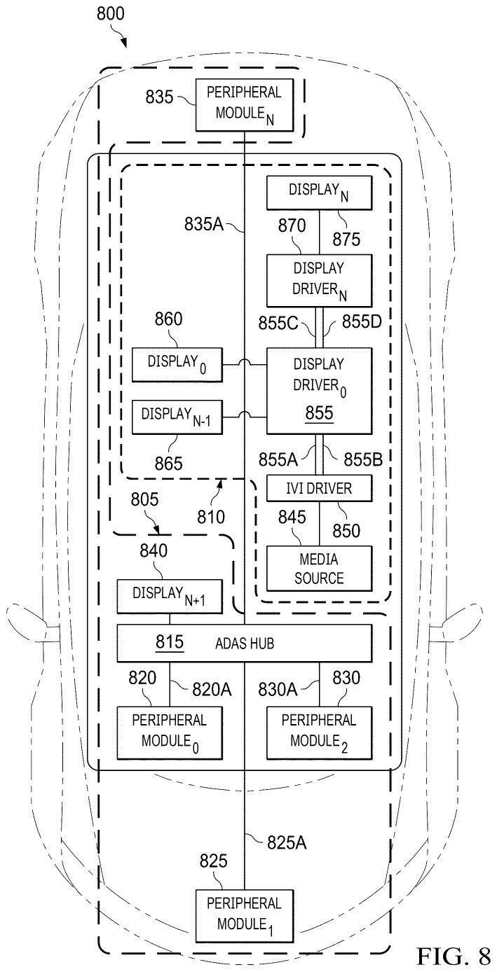

FIG. 8 is a block diagram of an example vehicle 800 including an example advanced driver-assistance (ADAS) system 805 and an example in-vehicle infotainment (IVI) system 810. The ADAS system 805 and the IVI system 810 may be referred to as flat panel display (FPD) link systems that may display media, such as images, multi-media content, etc. In some examples, the vehicle 800 may include one or more instances of the ADAS system 805 or the IVI system 810. For example, the vehicle 800 may include one or more instances of the ADAS system 805 without the IVI system 810. In another example, the vehicle 800 may include one or more instances of the IVI system 810 without the ADAS system 805. In yet another example, the vehicle 800 may include one or more instances of the ADAS system 805 and one or more instances of the IVI system 810. In the example of FIG. 8, the vehicle 800 is illustrated as a system for traversing distances, such as a car, a truck, etc. Alternatively, the vehicle 800 may be replaced, illustrated, or described as an alternative distributed display system, such as a boat, airplane, spacecraft, workstation, control panel, etc.

The ADAS system 805 of FIG. 8 includes an example ADAS hub 815, a first example peripheral module 820, a second example peripheral module 825, a third example peripheral module 830, a fourth example peripheral module 835, and an example display 840. Alternatively, the ADAS system 805 may include any number of peripheral module(s) or display(s).

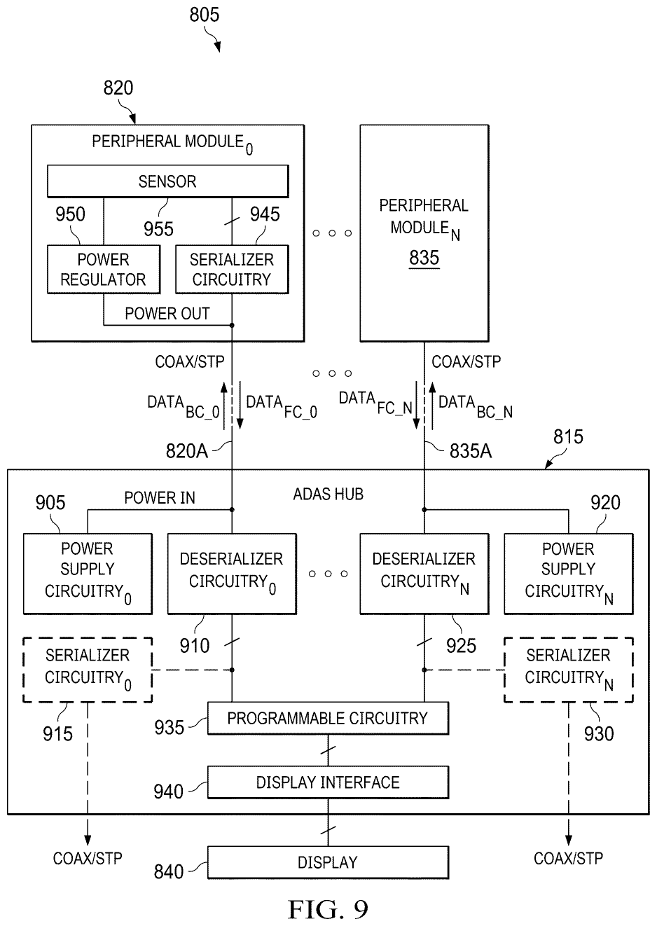

The ADAS system 805 is an example type of FPD-link system that utilizes serializing and deserializing data for driving assistance in the vehicle 800. In some examples, the ADAS system 805 utilizes serializing and deserializing media for an alternative implementation of processing, storing, or displaying data, such as a security system, recording system, etc. In some examples, the ADAS system 805 is an example camera system that facilitates at least one of the storing, processing, or displaying multi-media data (e.g., images, videos, etc.) from one or more sensors, such as cameras. In other examples, the ADAS system 805 may facilitate at least one of the storing, processing, or displaying an alternative type of data from one or more alternative types of sensors (e.g., lidar, radar, ultrasonic, etc.). An example of the ADAS system 805 is further illustrated and described in connection with FIG. 9.

The ADAS hub 815 is communicatively coupled to the peripheral modules 820, 825, 830, 835 and the display 840. The ADAS hub 815 uses full duplex communications to transmit data to and receive data from the peripheral modules 820, 825, 830, 835. In some examples, the ADAS hub 815 uses low-voltage differential signaling (LVDS) to communicate with the peripheral modules 820, 825, 830, 835. Alternatively, the ADAS hub 815 may use an alternative type of signaling to communicate with the peripheral modules 820, 825, 830, 835, such as display serial interface (DSI), embedded display port (eDP), etc. The ADAS hub 815 may at least one of store, process, or display data from the peripheral modules 820, 825, 830, 835. In the example of FIG. 8, the ADAS hub 815 displays the data from one or more of the peripheral modules 820, 825, 830, 835 using the display 840. The ADAS hub 815 uses multi-lane signaling to display data using the display 840. Also, the ADAS hub 815 may also at least one of store or process data from the peripheral modules 820, 825, 830, 835 for other functions of the vehicle 800, such as object recognition, time of flight calculations, etc. An example of the ADAS hub 815 is further illustrated and described in connection with FIG. 9.

The peripheral modules 820, 825, 830, 835 are communicatively coupled to the ADAS hub 815. The peripheral modules 820, 825, 830, 835 include at least one sensor that receives information of the surrounding environment, such as images, videos, time of flight measurements, beamforming data, etc. The peripheral modules 820, 825, 830, 835 transmit the received sensor data to the ADAS hub 815 using communication channels 820A, 825A, 830A, 835A. In some examples, the communication channel 101 of FIG. 1 represents at least one of the communication channels 820A, 825A, 830A, 835A. In some examples, the communication channels 820A, 825A, 830A, 835A are coaxial connectors, which couple the ADAS hub 815 to the peripheral modules 820, 825, 830, 835. In such examples, the ADAS hub 815 supplies power to the peripheral modules 820, 825, 830, 835 using power over coax (POC) across the communication channels 820A, 825A, 830A, 835A. Alternatively, the communication channels 820A, 825A, 830A, 835A may be formed by a different type of connector, such as a standard twisted pair (STP). An example of the peripheral modules 820, 825, 830, 835 are further illustrated and described in connection with FIG. 9.

In example operation of the ADAS system 805 of FIG. 8, the peripheral modules 820, 825, 830, 835 produce video streams of the environment surrounding the vehicle 800. The peripheral modules 820, 825, 830, 835 serialize data of the video streams. The peripheral modules 820, 825, 830, 835 transmit the serial data streams to ADAS hub 815 using the communication channels 820A, 825A, 830A, 835A. Concurrently, the ADAS hub 815 may transmit data to the peripheral modules 820, 825, 830, 835 using the communication channels 820A, 825A, 830A, 835A. Communications between the ADAS hub 815 and the peripheral modules 820, 825, 830, 835 may occur simultaneously. Such multi-directional communications across the same one of the communication channels 820A, 825A, 830A, 835A are referred to as full duplex communications.

In such example operations of the ADAS system 805 of FIG. 8, the ADAS hub 815 receives the serial data streams from the peripheral modules 820, 825, 830, 835. The ADAS hub 815 deserializes the data streams to reconstruct the video streams captured by the peripheral modules 820, 825, 830, 835. The ADAS hub 815 at least one of stores, processes, or displays the video streams for driver assistance. For example, the ADAS hub 815 displays the video stream of the peripheral module 835 on the display 840 responsive to a determination that the perspective corresponding to the peripheral module 835 is needed. In another example, the ADAS hub 815 stores or process video streams of the peripheral modules 820, 825, 830, 835 for detecting safety hazards in the environment of the vehicle 800.

Example operations of the ADAS system 805 are further described in connection with FIG. 9. Advantageously, serializing and deserializing data from the peripheral modules 820, 825, 830, 835 reduces the number of connections within the vehicle 800 to the ADAS hub 815. Advantageously, the serial data streams are capable of accurately traversing relatively large distances across the communication channels 820A, 825A, 830A, 835A.

The IVI system 810 of FIG. 8 includes an example media source 845, example IVI driver circuitry 850, a first example display driver 855, a first example display 860, a second example display 865, a second example display driver 870, and a third example display 875. Alternatively, the IVI system 810 may include any number of display driver(s) or display(s).

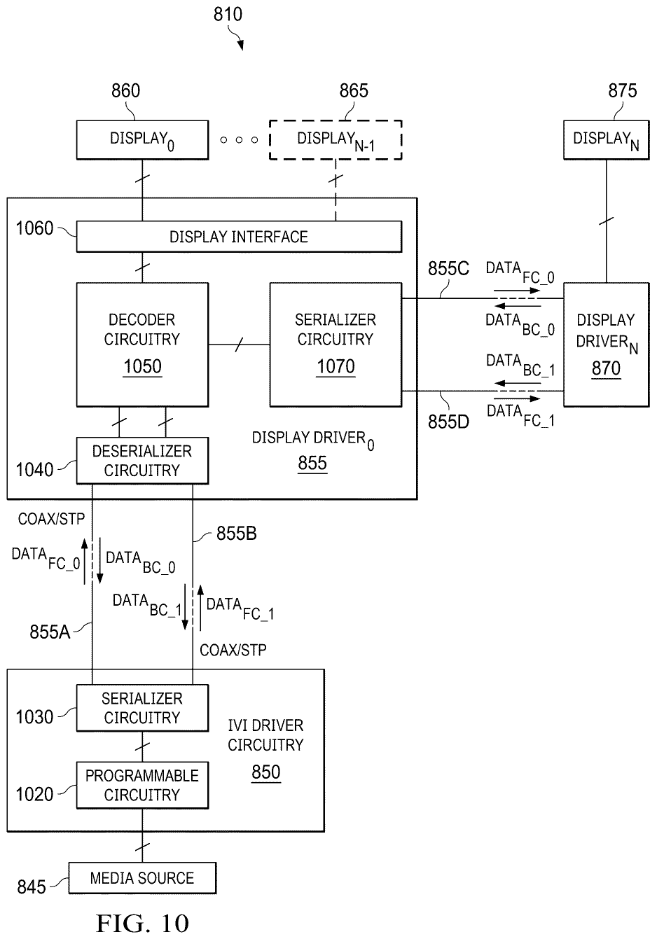

The IVI system 810 is an example type of FPD-link system that utilizes serializing and deserializing media for infotainment on one or more displays (e.g., the displays 860, 865, 875). In some examples, the IVI system 810 is a dashboard having multiple displays for displaying content. In other examples, the IVI system 810 is a different display system having multiple displays for displaying content, such as a studio, workstation, etc. In the example of FIG. 8, the IVI system 810 includes the media source 845, the IVI driver circuitry 850, the display drivers 855, 870, and the displays 860, 865, 875. Alternatively, the IVI system 810 may include any number of media source(s), display driver(s), or display(s). An example of the IVI system 810 is further illustrated and described in connection with FIG. 10.

In the IVI system 810, the media source 845 is coupled to the IVI driver circuitry 850. The media source 845 supplies media to the IVI driver circuitry 850 for display on one or more of the displays 860, 865, 875. In some examples, the media source 845 is integrated in the vehicle 800, such as circuitry supporting a data stream or memory storing media. In other examples, the media source 845 represents a connection to a device that is external to the vehicle 800, such as a wireless connection to a service hosting a multi-media stream.

The IVI driver circuitry 850 is communicatively coupled to the media source 845 and the display driver 855. The IVI driver circuitry 850 processes multi-media data from the media source 845 for transmission to one or more of the display drivers 855, 870. The IVI driver circuitry 850 uses full duplex communications to transmit data to and receive data from the display driver 855. In some examples, the IVI driver circuitry 850 uses LVDS to communicate with the display driver 855. In such examples, the IVI driver circuitry 850 indirectly communicates with the display driver 870 through the display driver 855. Such an example is further illustrated and described in connection with FIG. 10. Alternatively, the IVI driver circuitry 850 may use an alternative type of signaling to communicate with the display driver 855, such as DSI, eDP, etc. An example of the IVI driver circuitry 850 is further illustrated and described in connection with FIG. 10.

The display driver 855 is communicatively coupled to the IVI driver circuitry 850, the displays 860, 865, and the display driver 870. The display driver 855 interfaces with the IVI driver circuitry 850 using first and second communication channels 855A, 855B. In some examples, the communication channel 101 of FIG. 1 represents at least one of the communication channels 855A, 855B. The display driver 855 interfaces with the display driver 870 using communication channels 855C, 855D. In some examples, the communication channel 101 of FIG. 1 represents at least one of the communication channels 855C, 855D. In the example of FIG. 8, first and second coaxial connectors form the communication channels 855A, 855B between the IVI driver circuitry 850 and the display driver 855. Similarly, third and fourth coaxial connectors form the communication channels 855C, 855D between the display drivers 855, 870. The display driver 855 uses multi-lane signaling to display media on the displays 860, 865. In some examples, the display driver 855 decodes additional data from the IVI driver circuitry 850 to determine which one of the displays 860, 865 corresponds to the data. Although the display driver 855 of FIG. 8 is coupled to the displays 860, 865, the display driver 855 may be coupled to any number of display(s). An example of the display driver 855 is further illustrated and described in connection with FIG. 10.

The display driver 870 is communicatively coupled to the display driver 855 and the display 875. In some examples, the display driver 870 may be coupled to another instance of the display driver 870 (similar to the communication channels 855A, 855B, 855C, 855D of the display driver 855). The display driver 870 interfaces with the display driver 855 using the communication channels 855C, 855D. The display driver 870 uses multi-lane signaling to display multi-media data using the display 875. Although the display driver 855 of FIG. 8 is coupled to the display 875, the display driver 870 may be coupled to any number of display(s).

In an example operation of the IVI system 810 of FIG. 8, the media source 845 supplies media for display on at least one of the displays 860, 865, 875. The IVI driver circuitry 850 determines one or more of the displays 860, 865, 875 to display the media from the media source 845. The IVI driver circuitry 850 determines which of the display drivers 855, 870 are coupled to the one or more of the displays 860, 865, 875. The IVI driver circuitry 850 generates an identifier(s) that specifies at least one of the one or more of the display drivers 855, 870 or one or more of the displays 860, 865, 875. The IVI driver circuitry 850 combines the identifying data and the media from the media source 845. The IVI driver circuitry 850 generates a serial data stream by serializing the combined data for transmission on at least one of the communication channels 855A, 855B.

In such example operations of the IVI system 810, the display driver 855 receives the serial data stream representing the media and identifying data. The display driver 855 deserializes the serial data stream(s) from the communication channels 855A, 855B. The display driver 855 decodes the identifying data to determine if the media corresponds to either of the displays 860, 865. If the display driver 855 determines that the media corresponds to one or more of the displays 860, 865, the display driver 855 displays the media on one or more of the displays 860, 865. If the display driver 855 determines that the media does not correspond to one or more of the displays 860, 865, the display driver 855 regenerates the serial data stream by reserializing the combined media and identifying data. The display driver 855 transmits the serial data to the display driver 870 via at least one of the communication channels 855C, 855D. After receiving the serial data stream from the communication channels 855C, 855D, the display driver 855 deserializes the serial data stream(s). The display driver 870 decodes the identifying data to determine if the media corresponds to the display 875. If the display driver 870 determines that the identifying data corresponds to the display 875, the display driver 870 displays the media on the display 875. In some examples, the display drivers 855, 870 transmit serial data along the communication channels 855A, 855B, 855C, 855D to the IVI driver circuitry 850. In such examples, the concurrent communications from the display drivers 855, 870 may confirm reception or display of the media on one or more of the displays 860, 865, 875.

Example operations of the IVI system 810 are further described in connection with FIG. 3. Serializing and deserializing media from the media source 845 reduces the number of connections to the displays 860, 865, 875 within the vehicle 800. Also, the serial data streams are capable of accurately traversing relatively large distances across the communication channels 855A, 855B, 855C, 855D.

FIG. 9 is a block diagram of an example of the ADAS system 805 of FIG. 8 including the ADAS hub 815, the peripheral modules 820, 835, and the display 840 of FIG. 8. The example ADAS hub 815 of FIG. 9 includes first example power supply circuitry 905, first example deserializer circuitry 910, first example serializer circuitry 915, second example power supply circuitry 920, second example deserializer circuitry 925, second example serializer circuitry 930, example programmable circuitry 935, and example display interface circuitry 940. The example peripheral module 820 of FIG. 9 includes example serializer circuitry 945, example power regulator circuitry 950, and an example sensor 955.

The power supply circuitry 905 has an output coupled to the communication channel 820A and the deserializer circuitry 910. In some examples, the power supply circuitry 905 has an input coupled to a power storage or an electronic control unit (ECU), which supplies power. In other examples, the power supply circuitry 905 is in the peripheral module 820. In such examples, the power supply circuitry 905 directly supplies power to the peripheral module 820. Alternatively, a different method of powering the peripheral module 820 may be used in the circuitry described herein.

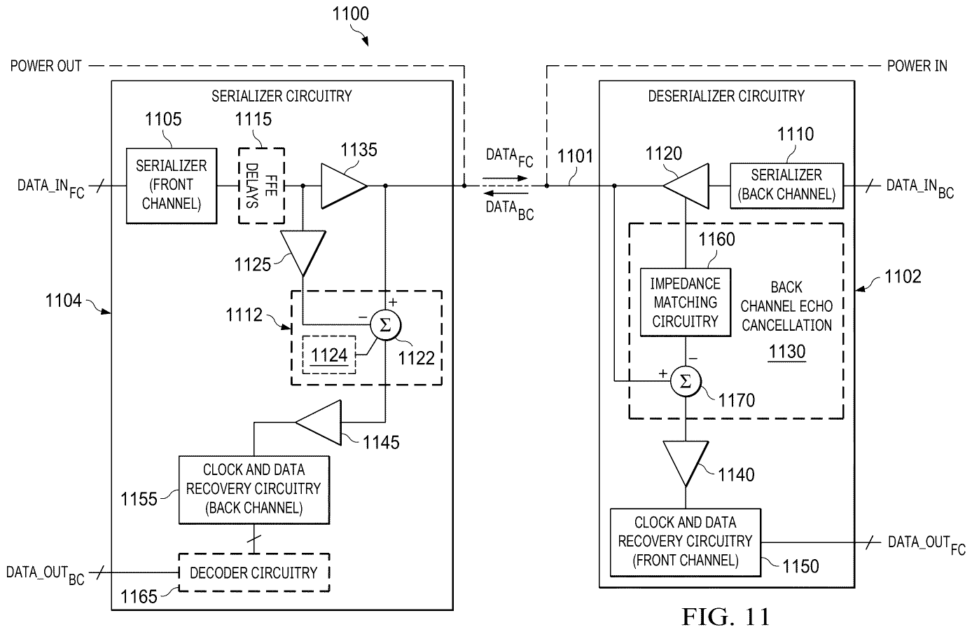

The deserializer circuitry 910 has an input and outputs. The input of the deserializer circuitry 910 is coupled to the communication channel 820A and the power supply circuitry 905. The outputs of the deserializer circuitry 910 are coupled to the serializer circuitry 915 and the programmable circuitry 935. In some examples, the deserializer circuitry 910 communicates with the peripheral module 820 using serial data streams along the communication channel 820A. An example of the deserializer circuitry 910 is further illustrated and described in connection with FIG. 11.

The serializer circuitry 915 has inputs and an output. The inputs of the serializer circuitry 915 are coupled to the deserializer circuitry 910 and the programmable circuitry 935. The output of the serializer circuitry 915 is structured to be coupled to an additional communication channel. In some examples, as illustrated by the dashed lines, the ADAS hub 115 may include the serializer circuitry 915 to connect the ADAS system 805 to external circuitry. In such examples, the serializer circuitry 915 may communicatively couple the ADAS system 805 to another ADAS system, the IVI system 810, storage medium, an ECU, etc. In other examples, the serializer circuitry 915 may be excluded from the ADAS hub 815.

The power supply circuitry 920 has an output coupled to the communication channel 835A and the deserializer circuitry 925. In some examples, the power supply circuitry 920 has an input coupled to a power storage or an ECU, which supplies power. In other examples, the power supply circuitry 920 is in the peripheral module 835. In such examples, the power supply circuitry 920 directly supplies power to the peripheral module 835. Alternatively, a different method of powering the peripheral module 135 may be used in the circuitry described herein.

The deserializer circuitry 925 has an input and outputs. The input of the deserializer circuitry 925 is coupled to the communication channel 135A and the power supply circuitry 920. The outputs of the deserializer circuitry 925 are coupled to the serializer circuitry 930 and the programmable circuitry 935. In some examples, the deserializer circuitry 925 communicates with the peripheral module 135 using serial data streams along the communication channel 835A. An example of the deserializer circuitry 925 is further illustrated and described in connection with FIG. 11.

The serializer circuitry 930 has inputs and an output. The inputs of the serializer circuitry 930 are coupled to the deserializer circuitry 925 and the programmable circuitry 935. The output of the serializer circuitry 930 is structured to be coupled to an additional communication channel. In some examples, as illustrated by the dashed lines, the ADAS hub 815 may include the serializer circuitry 930 to connect the ADAS system 805 to external circuitry. In such examples, the serializer circuitry 930 may communicatively couple the ADAS system 805 to another ADAS system, the IVI system 810, storage medium, an ECU, etc. In other examples, the serializer circuitry 930 may be excluded from the ADAS hub 815.

The programmable circuitry 935 has first inputs, second inputs, and outputs. The first inputs of the programmable circuitry 935 are coupled to the deserializer circuitry 910 and the serializer circuitry 915. The second inputs of the programmable circuitry 935 are coupled to the deserializer circuitry 925 and the serializer circuitry 930. The outputs of the programmable circuitry 935 are coupled to the display interface circuitry 940. In some examples, the programmable circuitry 935 instantiates circuitry responsive to an execution of machine-readable instructions. In such examples, the programmable circuitry 935 may be one of a central processing unit (CPU), a graphic processing unit (GPU), multi-core processing unit (MCU), etc. Alternatively, the programmable circuitry 935 may be an application specific integrated circuit (ASIC) structured to at least one of store, process, or condition data from the deserializer circuitry 910, 925.

The display interface circuitry 940 has inputs and outputs. The inputs of the display interface circuitry 940 are coupled to the programmable circuitry 935. The outputs of the display interface circuitry 940 are coupled to the display 840. In some examples, the display interface circuitry 940 represents a display driver, which converts data from the programmable circuitry 935 to drive the display 840. In some such examples, the display interface circuitry 940 may include a port and connector specific for driving the display 840, such as a display port, a high-definition multimedia interface (HDMI) port, etc.

The serializer circuitry 945 has inputs and an output. The inputs of the serializer circuitry 945 are coupled to the sensor 955. The output of the serializer circuitry 945 is coupled to the communication channel 820A and the power regulator circuitry 950. In some examples, the serializer circuitry 945 communicates with the ADAS hub 815 using serial data streams along the communication channel 820A. An example of the serializer circuitry 945 is further illustrated and described in connection with FIG. 11.

In the example of FIG. 9, the deserializer circuitry 910 is communicatively coupled to the serializer circuitry 945 by a full duplex wireline connection represented by the communication channel 820A. In some examples, both the deserializer circuitry 910 and the serializer circuitry 945 may receive data from or transmit data on the communication channel 820A. In such examples, the input of the deserializer circuitry 910 and the output of the serializer circuitry 945 are bi-directional. Such an example is further described in connection with FIG. 4.

The power regulator circuitry 950 has an input and an output. The input of the power regulator circuitry 950 is coupled to the communication channel 820A and the serializer circuitry 945. The output of the power regulator circuitry 950 is coupled to the sensor 955. The power regulator circuitry 950 receives power from the power supply circuitry 905. In some examples, such as in FIG. 9, the power regulator circuitry 950 receives power through the communication channel 820A. In other examples, the power supply circuitry 905 may be coupled to the power regulator circuitry 950 by a separate connection or positioned in proximity to the peripheral module 820.

The sensor 955 has an input and outputs. The input of sensor 955 is coupled to the power regulator circuitry 950. The outputs of the sensor 955 are coupled to the serializer circuitry 945. In some examples, the sensor 955 produces data corresponding to a surrounding environment. For example, in FIG. 8, the sensor 955 may be a camera positioned to capture a portion of the environment surrounding the vehicle 800. In another example, the sensor 955 may be an alternative type of sensor for corresponding to characteristics of the surrounding environment of the vehicle 800, such as obstacles.

In example operation, the power supply circuitry 905 supplies power to the power regulator circuitry 950 through the communication channel 820A. In some examples, such as the communication channel 820A being a coaxial connector, the power supply circuitry 905 and the power regulator circuitry 950 implement power over coax (POC). In such examples, the power supply circuitry 905 supplies power (POWER IN) and the power regulator circuitry 950 receives power (POWER OUT). The power regulator circuitry 950 powers the sensor 955, or more generally the peripheral module 820 based on power from the power supply circuitry 905. Similarly, the power supply circuitry 920 may utilize the communication channel 835A to supply power to the peripheral module 835.

The sensor 955 generates data corresponding to the surrounding environment. In some examples, the sensor 955 is a camera that produces multimedia data corresponding to a perspective of the surrounding environment. In another example, the sensor 955 is a lidar device that produces time of flight data corresponding to potential obstacles in the surrounding environment. In yet another example, the sensor 955 is a radar that produces beamforming data corresponding to the surrounding environment. Alternatively, the sensor 955 may be an alternative type of sensor that produces an alternative type of data. In such example operations, the sensor 955 produces sensor data using multiple parallel data paths (also referred to as lines or lanes). The serializer circuitry 945 serializes data of the multiple parallel data paths to produce a serial data stream having a data rate greater than the data rate of the parallel data paths from the sensor 955. The serializer circuitry 945 transmits the serial data stream to the deserializer circuitry 910 using a front channel of the communication channel 820A. Such data of the serial data stream is referred to as front channel data (DATA_{FC_0}).

In example operation, the deserializer circuitry 910 receives the serial data stream after traversing the communication channel 820A. Concurrently, the deserializer circuitry 910 may transmit a serial data stream to the serializer circuitry 945 using a back-channel of the communication channel 820A. Such data is referred to as back-channel data (DATA_{BC_0}). In such examples, the front channel data has a data rate greater than the back-channel data to reduce interference. Such multi-directional communications along the communication channel 820A are referred to as full-duplex communications. The deserializer circuitry 910 may use the back-channel of the communication channel 820A to control settings of the sensor 955 or verify reception of data on the front channel. Similarly, the peripheral module 835 and the deserializer circuitry 925 may utilize full-duplex communications along the communication channel 835A to exchange front and back-channel data (DATA_{FC_N}, DATA_{BC_N}).

In example operation, the deserializer circuitry 910 deserializes the front channel data to produce multiple parallel data paths. In some examples, the deserializer circuitry 910 may decode identifying data from the front channel data. In such examples, the serializer circuitry 915 may serialize and transmit the front channel data to external circuitry responsive to the deserializer circuitry 910 decoding identifying data corresponding to external circuitry. Advantageously, the serializer circuitry 915 allows the ADAS system 805 to be coupled to another instance of the ADAS system 805, the IVI system 810, or alternative type of data processing system.

In example operation, the programmable circuitry 935 at least one of processes, stores, or conditions the data of the multiple parallel data paths for the display 840. In some examples, the programmable circuitry 935 combines data from the peripheral modules 820, 835 prior to display. For example, the programmable circuitry 935 may stitch video streams from the peripheral modules 820, 835 to display a larger portion of the surrounding environment. In such examples, the display interface circuitry 940 structures the data from the programmable circuitry 935 to drive the display 840. In some examples, the display interface circuitry 940 is at least one of a column pixel driver or a row pixel driver. The display 840 produces a perceivable representation of the data from at least one of the peripheral modules 820, 835.

Example operations of the serializer and deserializer system of the ADAS system 805 are further described in connection with FIG. 11. Advantageously, serializing and deserializing data from the peripheral modules 820, 835 reduces the number of connections to the ADAS hub 815. Advantageously, the serial data streams are capable of accurately traversing relatively large distances across the communication channels 820A, 835A.

FIG. 10 is a block diagram of an example of the IVI system 810 of FIG. 8. The IVI system 810 of FIG. 10 includes the media source 845, the IVI driver circuitry 850, the example of the display driver 855, 870, and the displays 860, 865, 875 of FIG. 8. The example IVI driver circuitry 850 of FIG. 10 includes example programmable circuitry 1020 and example serializer circuitry 1030. The example display driver 855 of FIG. 10 includes example deserializer circuitry 1040, example decoder circuitry 1050, example display interface circuitry 1060, and example serializer circuitry 1070.

The programmable circuitry 1020 has an input and outputs. The input of the programmable circuitry 1020 is coupled to the media source 845. The outputs of the programmable circuitry 1020 are coupled to the serializer circuitry 1030. In some examples, the programmable circuitry 1020 instantiates circuitry responsive to the execution of machine-readable instructions. In such examples, the programmable circuitry 1020 may be one of a CPU, a GPU, an MCU, etc. Alternatively, the programmable circuitry 935 may be an ASIC structured to at least one of store, process, or condition data from the media source 845.

The serializer circuitry 1030 has inputs, a first output, and a second output. The inputs of the serializer circuitry 1030 are coupled to the programmable circuitry 1020. The first output of the serializer circuitry 1030 is coupled to the communication channel 855A. The second output of the serializer circuitry 1030 is coupled to the communication channel 855B. In some examples, the serializer circuitry 1030 communicates with the display driver 855 using serial data streams along the communication channels 855A, 855B. An example of the serializer circuitry 1030 is further illustrated and described in connection with FIG. 4. Unlike the serializer circuitry 945 of FIG. 9, the serializer circuitry 1030 exchanges data using multiple serial data streams along the communication channels 855A, 855B. In some examples, the serializer circuitry 1030 may be illustrated and described as a plurality of instances of the serializer circuitry 1030 supporting a single one of the communication channels 855A, 855B. For example, the serializer circuitry 1030 may be separated into two instances of the serializer circuitry 1030.

The deserializer circuitry 1040 has a first input, a second input, and outputs. The first input of the deserializer circuitry 1040 is coupled to the communication channel 855A. The second input of the deserializer circuitry 1040 is coupled to the communication channel 855B. The outputs of the deserializer circuitry 1040 are coupled to the decoder circuitry 1050. In some examples, the deserializer circuitry 1040 communicates with the IVI driver circuitry 150 using serial data streams along the communication channels 855A, 855B. An example of the deserializer circuitry 1040 is further illustrated and described in connection with FIG. 4. Unlike the deserializer circuitry 910, 925 of FIG. 9, the deserializer circuitry 1040 exchanges data using multiple serial data streams along the communication channels 855A, 855B. In some examples, the deserializer circuitry 1040 may be illustrated and described as a plurality of instances of the deserializer circuitry 1040 supporting a single one of the communication channels 855A, 855B. For example, the deserializer circuitry 1040 may be separated into two instances of the deserializer circuitry 1040, such as the deserializer circuitry 910, 925 of FIG. 9.

The decoder circuitry 1050 has inputs, first outputs, and second outputs. The inputs of the decoder circuitry 1050 are coupled to the deserializer circuitry 1040. The first outputs of the decoder circuitry 1050 are coupled to the display interface 1060. The second outputs of the decoder circuitry 1050 are coupled to the serializer circuitry 1070. In some examples, the decoder circuitry 1050 is implemented using programmable circuitry or an ASIC. In such examples, the decoder circuitry 1050 is structured to route data from the deserializer circuitry 1040 to at least one of the display interface 1060 or the serializer circuitry 1070 responsive to the decoded portions of the data. Such portions of the data from the deserializer circuitry 1040 may be referred to as identifying data, which specifies one or more of the displays 860, 865, 875 to display the media on.

The display interface 1060 has inputs, first outputs, and second outputs. The inputs of the display interface 1060 are coupled to the decoder circuitry 1050. The first outputs of the display interface 1060 are coupled to the display 860. The second outputs of the display interface 1060 are coupled to the display 865. In some examples, the display interface 1060 drives one or more of the displays 860, 865 responsive to data from the decoder circuitry 1050. In some such examples, the display interface 1060 may include a port and connector specific for driving the displays, such as a display port, an HDMI port, etc. In the example of FIG. 10, the display interface 1060 drives the displays 860, 865. Alternatively, the display driver 855 may include any number of display interfaces 1060 for driving any number of displays, such as the displays 860, 865.

The serializer circuitry 1070 has inputs, a first output, and a second output. The inputs of the serializer circuitry 1070 are coupled to the decoder circuitry 1050. The first output of the serializer circuitry 1070 is coupled to the communication channel 855C. The second output of the serializer circuitry 1070 is coupled to the communication channel 855D. In some examples, the serializer circuitry 1070 communicates with the display driver 870 using serial data streams along the communication channels 855C, 855D. An example of the serializer circuitry 1070 is further illustrated and described in connection with FIG. 11. Similar to the serializer circuitry 1030, the serializer circuitry 1070 exchanges data using multiple serial data streams along the communication channels 855C, 855D. In some examples, the serializer circuitry 1070 may be illustrated and described as a plurality of instances of the serializer circuitry 1070 supporting one of the communication channels 855C, 855D. For example, the serializer circuitry 1070 may be separated into two instances of the serializer circuitry 1070.

In example operations, the programmable circuitry 1020 receives multimedia data from the media source 845. In some examples, the media source 845 is internal to the IVI system 810, such as memory storage, an ECU, a media stream, etc. In other examples, the media source 845 is external to the IVI system 810, such as a wireless connection to a service hosting a multi-media stream. The programmable circuitry 1020 identifies one or more of the displays 860, 865, 875 that correspond to the data from the media source 845. In some examples, the programmable circuitry 1020 encodes additional data onto the data from the media source 845 corresponding to different operations of the IVI system 810. For example, the programmable circuitry 1020 adds identifying data into portions of the data from the media source 845 to specify one or more of the displays 860, 865, 875 that correspond to the media. In such examples, the identifying data may specify the one or more of the displays 860, 865, 875. The programmable circuitry 1020 supplies the data to the serializer circuitry 1030 for transmission to the display drivers 855, 870.

In example operations, the serializer circuitry 1030 receives data from the programmable circuitry 1020 on multiple parallel data paths. The serializer circuitry 1030 serializes data of the multiple parallel data paths to produce a first and second serial data stream having a data rate greater than the data rate of the parallel data paths from the programmable circuitry 1020. The serializer circuitry 1030 transmits the first serial data stream to the deserializer circuitry 1040 using a front channel of the communication channel 855A. The data of the first serial data stream is referred to as first front channel data (DATA_{FC_0}). The serializer circuitry 1030 transmits the second serial data stream to the deserializer circuitry 1040 using a front channel of the communication channel 855B. The data of the second serial data stream is referred to as second front channel data (DATA_{FC_1}). Advantageously, increasing the number of communication channels between the serializer circuitry 1030 and the deserializer circuitry 1040 increases the possible number of displays the IVI system 810 may support at a given time.

In example operation, the deserializer circuitry 1040 receives the first and second serial data streams after traversing the communication channels 855A, 855B. Concurrently, the deserializer circuitry 1040 may transmit a first serial data stream to the serializer circuitry 1030 using a back-channel of the communication channel 855A. The data of the first serial data stream is referred to as first back-channel data (DATA_{BC_0}). Similarly, the deserializer circuitry 1040 may transmit a second serial data stream to the serializer circuitry 1030 using a back-channel of the communication channel 855B. The data of the second serial data stream is referred to as second back-channel data (DATA_{BC_1}). In such examples, the first and second front channel data has a data rate may be greater than the first and second back-channel data to reduce interference. Such multi-directional communications along the communication channels 855A, 855B are referred to as full-duplex communications. The deserializer circuitry 1040 may use the back-channel of the communication channels 855A, 855B to verify reception of the first and second front channel data, report errors to the programmable circuitry 1020, etc. Similarly, the display driver 170 and the serializer circuitry 1070 may utilize full-duplex communications along the communication channels 855C, 855D to exchange third and fourth front channel data (DATA_{FC_2}, DATA_{FC_3}) and third and fourth back-channel data (DATA_{BC_2}, DATA_{BC_3}).

In example operations, the deserializer circuitry 1040 deserializes the first and second front channel data to produce multiple parallel data paths. The decoder circuitry 1050 decodes the data from the media source 845 from the additional data from the programmable circuitry 1020. The decoder circuitry 1050 determines which one or more of the displays 860, 865, 875 correspond to the data from the media source 845 responsive to the decoded data. In some examples, the decoder circuitry 1050 supplies the multiple parallel data paths to the serializer circuitry 1070 responsive to a determination that the media does not correspond to the displays 860, 865. In such examples, the serializer circuitry 1070 serializes and transmits the third and fourth front channel data to the display driver 870. Advantageously, the display driver 870 may be coupled in series with another instance of the display driver 870 by additional communication channels, such as a fifth and sixth communication channel.

In example operation, the decoder circuitry supplies the multiple parallel data paths to the display interface 1060 responsive to a determination that the media from the media source 845 corresponds to at least one of the displays 860, 865. In some examples, the display interface 1060 structures the data from the decoder circuitry 1050 to drive one or more of the displays 860, 865. In some examples, the display interface 1060 is at least one of a column pixel driver or a row pixel driver. In such examples, at least one of the displays 860, 865 produce a perceivable representation of the media from the media source 845 responsive to the display interface 1060.

Example operations of the serializer and deserializer system of the IVI system 810 are further described in connection with FIG11. Advantageously, serializing and deserializing data from the media source 845 reduces the number of connections to one or more of the displays 860, 865, 875. Also, the serial data streams are capable of accurately traversing relatively large distances across the communication channels 855A, 855B, 855C, 855D.

FIG. 11 is a block diagram of an example serial-deserializer (SerDes) system 1100, which is a full-duplex communication system, including deserializer circuitry 1102, which is an example of the deserializer circuitry 910, 925, 1040 of FIGS. 9 and 10, and serializer circuitry 1104, which is an example of serializer circuitry 945, 1030 of FIGS. 9 and 10. The SerDes system 1100 includes an example communication channel 1101 coupled between the deserializer circuitry 1102 and the serializer circuitry 1104. In some examples, the communication channel 1101 is a coaxal connector. In other examples, the communication channel 1101 is a standard wire pair or alternative connection. In some examples, the communication channel 1101 represents the communication channel 101 of FIG. 1, or communication channels 820A, 835A, 855A, 855B of FIG. 8.

The example deserializer circuitry 1102 of FIG. 11 includes an example serializer 1110, example back-channel transmitter circuitry 1120, example back-channel echo cancellation circuitry 1130, example receiver circuitry 1140, and example clock and data recovery (CDR) circuitry 1150. The example echo cancellation circuitry 1130 includes example impedance matching circuitry 1160 and example combination circuitry 1170.

The deserializer circuitry 1102 is coupled to the serializer circuitry 1104 by the communication channel 1101. The deserializer circuitry 1102 has inputs (DATA_IN_{BC}) and outputs (DATA_OUT_{FC}). The inputs and outputs of the deserializer circuitry 1102 are structured to be coupled to one of the programmable circuitry 935 of FIG. 9 or the decoder circuitry 1050 of FIG. 10. The inputs of the deserializer circuitry 1102 receive back-channel data for transmission along the communication channel 1101 (e.g., or any of communication channels 101 of FIGS. 1, 820A, 835A, 855A, 855B of FIG. 8, etc.). The outputs of the deserializer circuitry 1102 provide front channel data from the communication channel 1101.

The serializer 1110 has inputs and an output. The inputs of the serializer 1110 are coupled to the inputs of the deserializer circuitry 1102 (DATA_IN_{BC}). The output of the serializer 1110 is coupled to the transmitter circuitry 1120. In some examples, the serializer 1110 is referred to as a back-channel serializer.

The transmitter circuitry 1120 has an input, a first output, and a second output. The input of the transmitter circuitry 1120 is coupled to the serializer 1110. The first output of the transmitter circuitry 1120 is coupled to the echo cancellation circuitry 1130 and communication channel 1101. The second output of the transmitter circuitry 1120 is coupled to the echo cancellation circuitry 1130. In some examples, the transmitter circuitry 1120 is referred to as a back-channel transmitter.

The echo cancellation circuitry 1130 has a first input, a second input, and an output. The first input of the echo cancellation circuitry 1130 is coupled to the transmitter circuitry 1120. The second input of the echo cancellation circuitry 1130 is coupled to the transmitter circuitry 1120 and the communication channel 1101. The output of the echo cancellation circuitry 1130 is coupled to the receiver circuitry 1125. In some examples, the echo cancellation circuitry 1130 is referred to as back-channel echo cancellation circuitry.

The receiver circuitry 1140 has an input and an output. The input of the receiver circuitry 1140 is coupled to the echo cancellation circuitry 1130. The output of the receiver circuitry 1140 is coupled to the CDR circuitry 1150. In some examples, the receiver circuitry 1140 is referred to as a front channel receiver.

The CDR circuitry 1150 has an input and outputs. The input of the CDR circuitry 1150 is coupled to the receiver circuitry 1140. The outputs of the CDR circuitry 1150 are coupled to the outputs of the deserializer circuitry 1102 (DATA_OUT_{FC}). In some examples, the CDR circuitry 1150 is referred to as front channel CDR circuitry.

The impedance matching circuitry 1160 (also referred to as load circuitry) has an input and an output. The input of the load circuitry 1160 is coupled to the transmitter circuitry 1120. The output of the load circuitry 1160 is coupled to the combination circuitry 1170.

The combination circuitry 1170 has a first input, a second input, and an output. The first input of the combination circuitry 1170 is coupled to the transmitter circuitry 1120 and the communication channel 1101. The second input of the combination circuitry 1170 is coupled to the transmitter circuitry 1120. The output of the combination circuitry 1170 is coupled to the receiver circuitry 1140.
The example serializer circuitry 1104 of FIG. 11 includes an example serializer 1105, example delay circuitry 1115, first example transmitter circuitry 1135, second example transmitter circuitry 1125, example echo cancellation circuitry 1112, example receiver circuitry 1145, example CDR circuitry 1155, and example decoder circuitry 1165. The echo cancellation circuitry 1112 represents the echo cancellation circuitry 112 of FIGS. 1, 2, 3, and 5, and includes example combination circuitry 1122 and example common mode (CM) variation compensation circuitry 1124.
The serializer circuitry 1104 is coupled to the deserializer circuitry 1102 by the communication channel 1101. The serializer circuitry 1104 has inputs (DATA_IN_{FC}) and outputs (DATA_OUT_{BC}). The inputs and outputs of the serializer circuitry 1104 are structured to be coupled to one of the sensor 955 of FIG. 9 or the programmable circuitry 1020 of FIG. 10. The inputs of the serializer circuitry 1104 receive front channel data for transmission along the communication channel 1101. The outputs of the serializer circuitry 1104 provide back-channel data from the communication channel 1101.

The serializer 1105 has inputs and an output. The inputs of the serializer 1105 are coupled to the inputs of the serializer circuitry 1104 (DATA_IN_{FC}). The output of the serializer 1105 is coupled to the delay circuitry 1115. In some examples, the serializer circuitry 1104 is referred to as a front-channel serializer.

The delay circuitry 1115 has an input and an output. The input of the delay circuitry 1115 is coupled to the serializer 1105. The output of the delay circuitry 1115 is coupled to the transmitter circuitry 1135, 1125.

The transmitter circuitry 1125 has an input and an output. The input of the transmitter circuitry 1125 is coupled to the delay circuitry 1115 and the transmitter circuitry 1135. The output of the transmitter circuitry 1125 is coupled to the combination circuitry 1122 of the echo cancellation circuitry 1112. In some examples, the transmitter circuitry 1125 is referred to as a secondary transmitter or replica transmitter circuitry. In some examples, the transmitter circuitry 1125 represents the secondary transmitter circuitry 110 of FIG. 1.

The transmitter circuitry 1135 has an input and an output. The input of the transmitter circuitry 1135 is coupled to the delay circuitry 1115. In some examples, as illustrated by the dashed lines, the input of the transmitter circuitry 1125, 1135 are directly coupled to the output of the serializer 1105. The output of the transmitter circuitry 1135 is coupled to the combination circuitry 1122 and the communication channel 1101. In some examples, the transmitter circuitry 1135 is referred to as a front-channel transmitter or a primary transmitter. In some examples, the transmitter circuitry 1135 represents the primary transmitter circuitry 108 of FIG. 1.

The combination circuitry 1122 has a first input, a second input, and an output. The first input of the combination circuitry 1122 is coupled to the transmitter circuitry 1125. The second input of the combination circuitry 1122 is coupled to the transmitter circuitry 1135 and the communication channel 1101. The output of the combination circuitry 1122 is coupled to the receiver circuitry 1145. The CM variation compensation circuitry 1124 has an output. In some examples, the output of the CM variation compensation circuitry is coupled to a third input of the combination circuitry 1122. In the example of FIG. 11, the combination circuitry 1122 represents the combination circuitry 122 of FIGS. 1, 2, 3, and 5. In some examples, the CM variation compensation circuitry 1124 represents the CM variation compensation circuitry 124 of FIGS. 1, 2, and 5. In some examples, the combination circuitry 1122 is subtraction circuitry. Alternatively, in other examples, the combination circuitry 1122 is alternative circuitry.

The receiver circuitry 1145 has an input and an output. The input of the receiver circuitry 1145 is coupled to the combination circuitry 1122. The output of the receiver circuitry 1145 is coupled to the CDR circuitry 1155. In some examples, the receiver circuitry 1145 is referred to as a back-channel receiver. In some examples, the receiver circuitry 1145 represents the receiver circuitry 114 of FIG. 1.

The CDR circuitry 1155 has an input and outputs. The input of the CDR circuitry 1155 is coupled to the receiver circuitry 1145. The outputs of the CDR circuitry 1155 are coupled to the decoder circuitry 1165. In some examples, the CDR circuitry 1155 is referred to as back-channel CDR circuitry.

The decoder circuitry 1165 has inputs and outputs. The inputs of the decoder circuitry 1165 are coupled to the CDR circuitry 1155. The outputs of the decoder circuitry 1165 are coupled to the outputs of the serializer circuitry 1104 (DATA_OUT_{BC}). In some examples, as illustrated by the dashed lines, the outputs of the CDR circuitry 1155 are directly coupled to the outputs of the serializer circuitry 1104 (DATA_OUT_{BC}).

In example operations, the deserializer circuitry 1102 receives back-channel data (DATA_{BC}) via multiple data paths from an external data source, such as the programmable circuitry 935 or the decoder circuitry 1050 of FIGS. 9 and 10. The serializer 1110 produces a back-channel serial data stream responsive to the back-channel data. The transmitter circuitry 1120 transmits the back-channel data to the serializer circuitry 1104 across the communication channel 1101. Similarly, the serializer circuitry 1104 receives front channel data (DATA_{FC}) via multiple data paths from an external data source, such as the sensor 955 or the programmable circuitry 920. The serializer 1105 produces a front channel serial data stream responsive to the front channel data. In some examples, the serializer circuitry 1104 includes the delay circuitry 1115, which supports feed-forward equalization (FFE). In such examples, the delays of the delay circuitry 1115 modulate the amplitudes of digital pulses to reduce attenuation along the communication channel 1101. The transmitter circuitry 1135 transmits the front channel data to the deserializer circuitry 1102 across the communication channel 1101. Also, the transmitter circuitry 1125 provides a replica of the front channel data to the combination circuitry 1122.

In some examples, the transmitter circuitry 1120, 1135 may include circuitry to impedance match the communication channel 1101 to reduce reflections. Also, the transmitter circuitry 1120, 1135 may have different bandwidths. In such examples, the data rates of the transmissions of the front and back-channel data are different to prevent interference. In some examples, the bandwidth of the transmitter circuitry 1120, which transmits the back-channel data, is modified to reduce non-linear gain contributions of the communication channel 1101. Advantageously, the serializers 1110, 1105 and the transmitter circuitry 1120, 1135 support full-duplex data transmissions along the communication channel 1101.

In example operations, the deserializer circuitry 1102 receives the front channel data (DATA_{FC}) after propagating along the communication channel 1101. The receiver circuitry 1140 produces a serial data stream representing the front channel data responsive to signals from the communication channel 1101. In some examples, the receiver circuitry 1140 isolates the communication channel 1101 from the CDR circuitry 1150. The echo cancellation circuitry 1130 reduces contributions of the back-channel data from signals received by the transmitter circuitry 1120.

Similarly, the serializer circuitry 1104 receives the back-channel data (DATA_{BC}) after propagating along the communication channel 1101. The combination circuitry 1122 subtracts the replica front channel data from signals of the communication channel 1101. In some examples, the combination circuitry 1122 subtracts the replica front channel data from signals of the communication channel 1101 in the current mode domain to improve linearity of the combination circuitry 1122. In some examples, the combination circuitry 1122 rejects extraneous signals outside the bandwidth of the back-channel signal using a biquad filter. The CM variation compensation circuitry 1124 rejects common mode voltage variation from the transmitter circuitry 1135 to provide the combination circuitry 1122 with steady common mode current. The combination circuitry 1122 provides a communication signal representing the back-channel data to the receiver circuitry 1145. The receiver circuitry 1145 produces a serial data stream representing the back-channel data responsive to signals from the communication channel 1101. In some examples, the receiver circuitry 1145 isolates the communication channel 1101 from the CDR circuitry 1155. Also, the receiver circuitry 1140, 1145 terminate currents of the communication channel 1101.

In example operations, the CDR circuitry 1150 receives the front channel data from the receiver circuitry 1140. The CDR circuitry 1150 retimes the front channel data to produce multiple parallel data paths representing the front channel data. The outputs of the deserializer circuitry 1102 provide the front channel data to external circuitry, such as the programmable circuitry 935 or the decoder circuitry 1050. Similarly, the CDR circuitry 1155 receives the back-channel data from the receiver circuitry 1145. The CDR circuitry 1155 produces multiple parallel data paths representing the back-channel data. In some such example operations, the decoder circuitry 1165 decodes portions of the back-channel data prior to the outputs of the serializer circuitry 1104 supplying the back-channel data to external circuitry, such as the sensor 955 or the programmable circuitry 1020.

Advantageously, serializing and deserializing front and back-channel data reduces the number of connections that need to traverse relatively large distances of the communication channel 1101. Advantageously, the serial data streams are capable of accurately traversing relatively large distances across the communication channels 1101.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means +/-10 percent of the stated value, or, if the value is zero, a reasonable range of values around zero.

Example methods, apparatus, systems, and articles of manufacture for echo cancellation in transceivers are disclosed herein. Further examples and combinations thereof include the following:
Example 1 includes an apparatus comprising a first resistor having a first terminal and a second terminal, a second resistor having a first terminal and a second terminal, the second terminal of the second resistor coupled to the second terminal of the first resistor, a first transistor having a first terminal, a second terminal, and a control terminal, the second terminal of the first transistor coupled to the second terminals of the first resistor and second resistor, a second transistor having a first terminal, a second terminal, and a control terminal, the second terminal of the second transistor coupled to the first terminal of the first transistor, a third resistor having a first terminal and a second terminal, a fourth resistor having a first terminal and a second terminal, the second terminal of the fourth resistor coupled to the second terminal of the third resistor, a third transistor having a first terminal, a second terminal, and a control terminal, the first terminal of the third transistor coupled to the control terminal of the first transistor, the second terminal of the third transistor coupled to the second terminals of the third resistor and the fourth resistor, and the control terminal of the third transistor coupled to the first terminal of the first transistor and to the second terminal of the second transistor, and a fourth transistor having a first terminal, a second terminal, and a control terminal, the second terminal of the fourth transistor coupled to the first terminal of the third transistor and to the control terminal of the first transistor, the control terminal of the fourth transistor coupled to control terminal of the second transistor.
Example 2 includes the apparatus of example 1, further including a first capacitor having a first terminal and a second terminal, the first terminal of the first capacitor coupled to the second terminal of the first transistor, the second terminal of the first resistor, and the second terminal of the second resistor, a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor, a third capacitor having a first terminal and a second terminal, the first terminal of the third capacitor coupled to the second terminal of the second transistor, the control terminal of the third transistor, and the first terminal of the first transistor, and a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor.
Example 3 includes the apparatus of example 2, wherein the first capacitor, the second capacitor, the third capacitor, and the fourth capacitor are tunable capacitors.
Example 4 includes the apparatus of example 1, further including a fifth transistor having a first terminal, a second terminal, and a control terminal, the first terminal of the fifth transistor coupled to the second terminal of the third transistor, the second terminal of the third resistor, and the second terminal of the fourth resistor, the second terminal of the fifth transistor coupled to ground, and the control terminal of the fifth transistor coupled to second terminal of the first resistor and the second terminal of the second resistor, and a sixth transistor having a first terminal, a second terminal, and a control terminal, the first terminal of the sixth transistor coupled to the second terminal of the first transistor, the second terminal of the first resistor, and the second terminal of the second resistor, the second terminal of the sixth transistor coupled to ground, and the control terminal of the sixth transistor coupled to the second terminal of the third resistor and the second terminal of the fourth resistor.
Example 5 includes the apparatus of example 1, further including a fifth resistor having a first terminal and a second terminal, the first terminal of the fifth resistor coupled to the first terminal of the second transistor, and the second terminal of the fifth resistor coupled to the control terminal of the second transistor and the control terminal of the fourth transistor, a first capacitor having a first terminal and a second terminal, the first terminal of the first capacitor coupled to the first terminal of the fifth resistor, the second terminal of the first capacitor coupled to the second terminal of the fifth resistor, a sixth resistor having a first terminal and a second terminal, the first terminal of the sixth resistor coupled to the first terminal of the fourth transistor, and the second terminal of the sixth resistor coupled to the control terminal of the second transistor and the control terminal of the fourth transistor, and a second capacitor having a first terminal and a second terminal, the first terminal of the second capacitor coupled to the first terminal of the sixth resistor, the second terminal of the second capacitor coupled to the second terminal of the sixth resistor.
Example 6 includes an apparatus comprising combination circuitry having a first resistor having a first terminal and a second terminal, a second resistor having a first terminal and a second terminal, the second terminal of the second resistor coupled to the second terminal of the first resistor, a third resistor having a first terminal and a second terminal, a fourth resistor having a first terminal and a second terminal, the second terminal of the fourth resistor coupled to the second terminal of the third resistor, a fifth resistor having a first terminal and a second terminal, the first terminal of the fifth resistor coupled to the second terminal of the first resistor and the second terminal of the second resistor, and a sixth resistor having a first terminal and a second terminal, the first terminal of the sixth resistor coupled to the second terminal of the fifth resistor, the second terminal of the sixth resistor coupled to the second terminal of the third resistor and the second terminal of the fourth resistor, a comparator having a first input, a reference terminal, and an output, the first input of the comparator coupled to the second terminal of the fifth resistor and to the first terminal of the sixth resistor, a first current source coupled to the output of the comparator, to the second terminal of the first resistor, to the second terminal of the second resistor, and to the first terminal of the fifth resistor, and a second current source coupled to the output of the comparator, to the second terminal of the third resistor, to the second terminal of the fourth resistor, and to the second terminal of the sixth resistor.
Example 7 includes the apparatus of example 6, wherein the combination circuitry includes a first transistor having a first terminal, a second terminal, and a control terminal, the second terminal of the first transistor coupled to the second terminal of the first resistor, to the second terminal of the second resistor, and to the first terminal of the fifth resistor, a second transistor having a first terminal, a second terminal, and a control terminal, the second terminal of the second transistor coupled to the first terminal of the first transistor, a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor, and a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor.
Example 8 includes the apparatus of example 7, further including a third current source having an output, a fifth transistor having a first terminal, a second terminal, and a control terminal, the first terminal of the fifth transistor coupled to the output of the third current source and to the control terminal of the fifth transistor, the control terminal of the fifth transistor coupled to the control terminal of the second transistor and to the control terminal of the fourth transistor, and a sixth transistor having a first terminal, a second terminal, and a control terminal, the first terminal of the sixth transistor coupled to the second terminal of the fifth transistor and to the control terminal of the sixth transistor, the second terminal of the sixth transistor coupled to the reference terminal of the comparator.
Example 9 includes the apparatus of example 6, wherein the combination circuitry further includes a first transistor having a first terminal, a second terminal, and a control terminal, the second terminal of the first transistor coupled to the second terminal of the first resistor, to the second terminal of the second resistor, and to the first terminal of the fifth resistor, a second transistor having a first terminal, a second terminal, and a control terminal, the second terminal of the second transistor coupled to the first terminal of the first transistor, a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor, a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor, a first capacitor having a first terminal and a second terminal, the first terminal of the first capacitor coupled to the second terminal of the first transistor, the second terminal of the first resistor, and the second terminal of the second resistor, a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor, a third capacitor having a first terminal and a second terminal, the first terminal of the third capacitor coupled to the second terminal of the second transistor, the control terminal of the third transistor, and the first terminal of the first transistor, and a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor.
Example 10 includes the apparatus of example 9, wherein the first capacitor, the second capacitor, the third capacitor, and the fourth capacitor are tunable capacitors.
Example 11 includes the apparatus of example 6, wherein the combination circuitry further includes a first transistor having a first terminal, a second terminal, and a control terminal, the second terminal of the first transistor coupled to the second terminal of the first resistor, to the second terminal of the second resistor, and to the first terminal of the fifth resistor, a second transistor having a first terminal, a second terminal, and a control terminal, the second terminal of the second transistor coupled to the first terminal of the first transistor, a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor, a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor, a fifth transistor having a first terminal, a second terminal, and a control terminal, the first terminal of the fifth transistor coupled to the second terminal of the third transistor, to the second terminal of the third resistor, and to the second terminal of the fourth resistor, the second terminal of the fifth transistor coupled to ground, and the control terminal of the fifth transistor coupled to the second terminal of the first resistor and to the second terminal of the second resistor, and a sixth transistor having a first terminal, a second terminal, and a control terminal, the first terminal of the sixth transistor coupled to the second terminal of the first transistor, the second terminal of the first resistor, and to the second terminal of the second resistor, the second terminal of the sixth transistor coupled to ground, and the control terminal of the sixth transistor coupled to the second terminal of the third resistor and to the second terminal of the fourth resistor.
Example 12 includes the apparatus of example 6, wherein the combination circuitry further includes a first transistor having a first terminal, a second terminal, and a control terminal, the second terminal of the first transistor coupled to the second terminal of the first resistor, to the second terminal of the second resistor, and to the first terminal of the fifth resistor, a second transistor having a first terminal, a second terminal, and a control terminal, the second terminal of the second transistor coupled to the first terminal of the first transistor, a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor (Rb right), the control terminal of the third transistor coupled to the first terminal of the first transistor and to the second terminal of the second transistor, a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor, a seventh resistor having a first terminal and a second terminal, the first terminal of the seventh resistor coupled to the first terminal of the second transistor, and the second terminal of the seventh resistor coupled to the control terminal of the second transistor and to the control terminal of the fourth transistor, a first capacitor having a first terminal and a second terminal, the first terminal of the first capacitor coupled to the first terminal of the seventh resistor, the second terminal of the first capacitor coupled to the second terminal of the seventh resistor, an eighth resistor having a first terminal and a second terminal, the first terminal of the eighth resistor coupled to the second terminal of the seventh resistor, the control terminal of the second transistor, the control terminal of the fourth transistor, the second terminal of the eighth resistor coupled to the first terminal of the fourth transistor, and a second capacitor having a first terminal and a second terminal, the first terminal of the second capacitor coupled to the first terminal of the eighth resistor, the second terminal of the second capacitor coupled to the second terminal of the eighth resistor.
Example 13 includes the apparatus of example 6, wherein the combination circuitry includes a first transistor having a first terminal, a second terminal, and a control terminal, the second terminal of the first transistor coupled to the second terminal of the first resistor, to the second terminal of the second resistor, and to the first terminal of the fifth resistor, a second transistor having a first terminal, a second terminal, and a control terminal, the second terminal of the second transistor coupled to the first terminal of the first transistor, a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor, a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor, a first capacitor having a first terminal and a second terminal, the first terminal of the first capacitor coupled to the second terminal of the first transistor, the second terminal of the first resistor, and the second terminal of the second resistor, a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor, a third capacitor having a first terminal and a second terminal, the first terminal of the third capacitor coupled to the second terminal of the second transistor, the control terminal of the third transistor, and the first terminal of the first transistor, a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor, a fifth transistor having a first terminal, a second terminal, and a control terminal, the first terminal of the fifth transistor coupled to the second terminal of the third transistor, to the second terminal of the third resistor, to the second terminal of the fourth resistor, and to the second terminal of the sixth resistor, the second terminal of the fifth transistor coupled to ground, and the control terminal of the fifth transistor coupled to second terminal of the first resistor and to the second terminal of the second resistor, a sixth transistor having a first terminal, a second terminal, and a control terminal, the first terminal of the sixth transistor coupled to the second terminal of the first transistor, to the second terminal of the first resistor, to the second terminal of the second resistor, and to the first terminal of the fifth resistor, the second terminal of the sixth transistor coupled to ground, and the control terminal of the sixth transistor coupled to the second terminal of the third resistor and to the second terminal of the fourth resistor, a seventh resistor having a first terminal and a second terminal, the first terminal of the seventh resistor coupled to the first terminal of the second transistor, and the second terminal of the seventh resistor coupled to the control terminal of the second transistor and to the control terminal of the fourth transistor, a first capacitor having a first terminal and a second terminal, the first terminal of the first capacitor coupled to the first terminal of the seventh resistor, the second terminal of the first capacitor coupled to the second terminal of the seventh resistor, an eighth resistor having a first terminal and a second terminal, the first terminal of the eighth resistor coupled to the second terminal of the seventh resistor, the control terminal of the second transistor, and to the control terminal of the fourth transistor, the second terminal of the eighth resistor coupled to the first terminal of the fourth transistor, a second capacitor having a first terminal and a second terminal, the first terminal of the second capacitor coupled to the first terminal of the eighth resistor, the second terminal of the second capacitor coupled to the second terminal of the eighth resistor, a third current source having an output, a seventh transistor having a first terminal, a second terminal, and a control terminal, the first terminal of the seventh transistor coupled to the output of the third current source and to the control terminal of the seventh transistor, the control terminal of the seventh transistor coupled to the control terminal of the second transistor and to the control terminal of the fourth transistor, and an eighth transistor having a first terminal, a second terminal, and a control terminal, the first terminal of the eighth transistor coupled to the second terminal of the seventh transistor and to the control terminal of the eighth transistor, the second terminal of the eighth transistor coupled to the reference terminal of the comparator.
Example 14 includes a system comprising a communication channel having an output, replica transmitter circuitry having an output, combination circuitry including voltage to current converter circuitry including a first resistor having a first terminal and a second terminal, the first terminal coupled to the output of the communication channel, a second resistor having a first terminal and a second terminal, the first terminal of the second resistor coupled to the output of the replica transmitter circuitry, the second terminal of the second resistor coupled to the second terminal of the first resistor, a third resistor having a first terminal and a second terminal, the first terminal coupled to the output of the communication channel, and a fourth resistor having a first terminal and a second terminal, the first terminal of the fourth resistor coupled to the output of the replica transmitter circuitry, the second terminal of the fourth resistor coupled to the second terminal of the third resistor, virtual ground circuitry including a first transistor having a first terminal, a second terminal, and a control terminal, the second terminal of the first transistor coupled to the second terminals of the first resistor and second resistor, a second transistor having a first terminal, a second terminal, and a control terminal, the second terminal of the second transistor coupled to the first terminal of the first transistor, a third transistor having a first terminal, a second terminal, and a control terminal, the first terminal coupled to the control terminal of the first transistor, the second terminal of the third transistor coupled to the second terminals of the third resistor and the fourth resistor, the, and the control terminal of the third transistor coupled to the first terminal of the first transistor and to the second terminal of the second transistor, and a fourth transistor having a first terminal, a second terminal, and a control terminal, the second terminal of the fourth transistor coupled to the first terminal of the third transistor and to the control terminal of the first transistor, the control terminal of the fourth transistor coupled to control terminal of the second transistor, and receiver circuitry having an input, the input of the receiver circuitry coupled to the first terminal of the second transistor and to the first terminal of the fourth transistor.
Example 15 includes the system of example 14, wherein the second terminal of the first resistor is coupled to the second terminal of the second resistor at a first node, the second terminal of the third resistor and the second terminal of the fourth resistor are coupled at a second node, a signal on the output of the communication channel includes combination of a forward channel signal and a back-channel signal, a signal on the output of the replica transmitter circuitry includes the forward channel signal, and the voltage to current converter circuitry is to convert the signal on the output of the communication channel to current based on the first resistor, convert the signal on the output of the replica transmitter circuitry to current based on the second resistor, sum the output current of the communication channel with the output current of the replica transmitter circuitry at the first node to determine the back-channel signal, wherein the signal on the output of the communication channel at the first resistor is positive and the signal on the output of the replica transmitter circuitry at the second resistor is negative, convert the signal on the output of the communication channel to current based on the third resistor, convert the signal on the output of the replica transmitter circuitry to current based on the fourth resistor, and sum the output current of the communication channel with the output current of the replica transmitter circuitry at the second node to determine the back-channel signal, wherein the signal on the output of the communication channel at the third resistor is negative and the signal on the output of the replica transmitter circuitry at the fourth resistor is positive.
Example 16 includes the system of example 14, wherein the second terminal of the first resistor is coupled to the second terminal of the second resistor at a first node, the second terminal of the third resistor and the second terminal of the fourth resistor are coupled at a second node, and the virtual ground circuitry generates a first virtual ground at the first node based on the first transistor and second transistor being cascoded and the first transistor being cross-coupled with the third transistor, and generates a second virtual ground at the second node based on the third transistor and fourth transistor being cascoded and the third transistor being cross-coupled with the first transistor.
Example 17 includes the system of example 16, wherein the cross-coupled first and third transistors create a low impedance at the first terminal of the first transistor and first terminal of the third transistor.
Example 18 includes the system of example 14, wherein a signal on the output of the communication channel includes a combination of a forward channel signal and a back-channel signal, a signal on the output of the replica transmitter circuitry includes the forward channel signal, and the voltage to current converter circuitry is to sum the signal on output of the communication channel with the signal on the output of the replica transmitter circuitry in a current domain to determine the back-channel signal, the system further includes a biquad filter to reject any residual frequencies corresponding to the forward channel signal after the voltage to current converter circuitry sums the signals on the outputs of the communication channel and replica transmitter circuitry.
Example 19 includes the system of example 18, wherein the biquad filter includes a first capacitor having a first terminal and a second terminal, the first terminal of the first capacitor coupled to the second terminal of the first transistor, the second terminal of the first resistor, and the second terminal of the second resistor, a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor, a third capacitor having a first terminal and a second terminal, the first terminal of the third capacitor coupled to the second terminal of the second transistor, the control terminal of the third transistor, and the first terminal of the first transistor, and a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor, wherein the first capacitor, second capacitor, third capacitor, and fourth capacitor are tunable to support different frequencies of the back-channel signal.
Example 20 includes the system of example 14, wherein a signal on the output of the communication channel is a single-ended signal, the combination circuitry further includes single to differential signal converter circuitry to convert the single-ended signal to a differential signal to balance a signal on an output at the first terminal of the second transistor with a signal on an output at the first terminal of the fourth transistor.
Example 21 includes the system of example 20, wherein the single to differential signal converter circuitry includes a fifth transistor having a first terminal, a second terminal, and a control terminal, the first terminal of the fifth transistor coupled to the second terminal of the third transistor, the second terminal of the third resistor, and the second terminal of the fourth resistor, the second terminal of the fifth transistor coupled to ground, and the control terminal of the fifth transistor coupled to second terminal of the first resistor and the second terminal of the second resistor, and a sixth transistor having a first terminal, a second terminal, and a control terminal, the first terminal of the sixth transistor coupled to the second terminal of the first transistor, the second terminal of the first resistor, and the second terminal of the second resistor, the second terminal of the sixth transistor coupled to ground, and the control terminal of the sixth transistor coupled to the second terminal of the third resistor and the second terminal of the fourth resistor.

Modifications are possible in the described embodiments, and other embodiments are possible, within the scope of the claims.

What is claimed is:

1. An apparatus comprising:
a first resistor having a first terminal and a second terminal;
a second resistor having a first terminal and a second terminal, the second terminal of the second resistor coupled to the second terminal of the first resistor;
a first transistor having a first terminal, a second terminal, and a control terminal, the second terminal of the first transistor coupled to the second terminals of the first resistor and second resistor;
a second transistor having a first terminal, a second terminal, and a control terminal, the second terminal of the second transistor coupled to the first terminal of the first transistor;
a third resistor having a first terminal and a second terminal;
a fourth resistor having a first terminal and a second terminal, the second terminal of the fourth resistor coupled to the second terminal of the third resistor;
a third transistor having a first terminal, a second terminal, and a control terminal, the first terminal of the third transistor coupled to the control terminal of the first transistor, the second terminal of the third transistor coupled to the second terminals of the third resistor and the fourth resistor, and the control terminal of the third transistor coupled to the first terminal of the first transistor and to the second terminal of the second transistor; and
a fourth transistor having a first terminal, a second terminal, and a control terminal, the second terminal of the fourth transistor coupled to the first terminal of the third transistor and to the control terminal of the first transistor, the control terminal of the fourth transistor coupled to control terminal of the second transistor.

2. The apparatus of claim 1, further including:
a first capacitor having a first terminal and a second terminal, the first terminal of the first capacitor coupled to the second terminal of the first transistor, the second terminal of the first resistor, and the second terminal of the second resistor;
a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor;
a third capacitor having a first terminal and a second terminal, the first terminal of the third capacitor coupled to the second terminal of the second transistor, the control terminal of the third transistor, and the first terminal of the first transistor; and
a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor.

3. The apparatus of claim 2, wherein the first capacitor, the second capacitor, the third capacitor, and the fourth capacitor are tunable capacitors.

4. The apparatus of claim 1, further including:
a fifth transistor having a first terminal, a second terminal, and a control terminal, the first terminal of the fifth transistor coupled to the second terminal of the third transistor, the second terminal of the third resistor, and the second terminal of the fourth resistor, the second terminal of the fifth transistor coupled to ground, and the control terminal of the fifth transistor coupled to second terminal of the first resistor and the second terminal of the second resistor; and
a sixth transistor having a first terminal, a second terminal, and a control terminal, the first terminal of the sixth transistor coupled to the second terminal of the first transistor, the second terminal of the first resistor, and the second terminal of the second resistor, the second terminal of the sixth transistor coupled to ground, and the control terminal of the sixth transistor coupled to the second terminal of the third resistor and the second terminal of the fourth resistor.

5. The apparatus of claim 1, further including:
a fifth resistor having a first terminal and a second terminal, the first terminal of the fifth resistor coupled to the first terminal of the second transistor, and the second terminal of the fifth resistor coupled to the control terminal of the second transistor and the control terminal of the fourth transistor;
a first capacitor having a first terminal and a second terminal, the first terminal of the first capacitor coupled to the first terminal of the fifth resistor, the second terminal of the first capacitor coupled to the second terminal of the fifth resistor;
a sixth resistor having a first terminal and a second terminal, the first terminal of the sixth resistor coupled to the first terminal of the fourth transistor, and the second terminal of the sixth resistor coupled to the control terminal of the second transistor and the control terminal of the fourth transistor; and
a second capacitor having a first terminal and a second terminal, the first terminal of the second capacitor coupled to the first terminal of the sixth resistor, the second terminal of the second capacitor coupled to the second terminal of the sixth resistor.

6. An apparatus comprising:
combination circuitry having:
a first resistor having a first terminal and a second terminal;
a second resistor having a first terminal and a second terminal, the second terminal of the second resistor coupled to the second terminal of the first resistor;
a third resistor having a first terminal and a second terminal;
a fourth resistor having a first terminal and a second terminal, the second terminal of the fourth resistor coupled to the second terminal of the third resistor;
a fifth resistor having a first terminal and a second terminal, the first terminal of the fifth resistor coupled to the second terminal of the first resistor and the second terminal of the second resistor; and
a sixth resistor having a first terminal and a second terminal, the first terminal of the sixth resistor coupled to the second terminal of the fifth resistor, the second terminal of the sixth resistor coupled to the second terminal of the third resistor and the second terminal of the fourth resistor;
a comparator having a first input, a reference terminal, and an output, the first input of the comparator coupled to the second terminal of the fifth resistor and to the first terminal of the sixth resistor;
a first current source coupled to the output of the comparator, to the second terminal of the first resistor, to the second terminal of the second resistor, and to the first terminal of the fifth resistor; and
a second current source coupled to the output of the comparator, to the second terminal of the third resistor, to the second terminal of the fourth resistor, and to the second terminal of the sixth resistor.

7. The apparatus of claim 6, wherein the combination circuitry includes:
a first transistor having a first terminal, a second terminal, and a control terminal, the second terminal of the first transistor coupled to the second terminal of the first resistor, to the second terminal of the second resistor, and to the first terminal of the fifth resistor;
a second transistor having a first terminal, a second terminal, and a control terminal, the second terminal of the second transistor coupled to the first terminal of the first transistor;
a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor; and
a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor.

8. The apparatus of claim 7, further including:
a third current source having an output;
a fifth transistor having a first terminal, a second terminal, and a control terminal, the first terminal of the fifth transistor coupled to the output of the third current source and to the control terminal of the fifth transistor, the control terminal of the fifth transistor coupled to the control terminal of the second transistor and to the control terminal of the fourth transistor; and
a sixth transistor having a first terminal, a second terminal, and a control terminal, the first terminal of the sixth transistor coupled to the second terminal of the fifth transistor and to the control terminal of the sixth transistor, the second terminal of the sixth transistor coupled to the reference terminal of the comparator.

9. The apparatus of claim 6, wherein the combination circuitry further includes:
a first transistor having a first terminal, a second terminal, and a control terminal, the second terminal of the first transistor coupled to the second terminal of the first resistor, to the second terminal of the second resistor, and to the first terminal of the fifth resistor;
a second transistor having a first terminal, a second terminal, and a control terminal, the second terminal of the second transistor coupled to the first terminal of the first transistor;
a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor;
a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor;
a first capacitor having a first terminal and a second terminal, the first terminal of the first capacitor coupled to the second terminal of the first transistor, the second terminal of the first resistor, and the second terminal of the second resistor;
a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor;
a third capacitor having a first terminal and a second terminal, the first terminal of the third capacitor coupled to the second terminal of the second transistor, the control terminal of the third transistor, and the first terminal of the first transistor; and
a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor.

10. The apparatus of claim 9, wherein the first capacitor, the second capacitor, the third capacitor, and the fourth capacitor are tunable capacitors.

11. The apparatus of claim 6, wherein the combination circuitry further includes:
a first transistor having a first terminal, a second terminal, and a control terminal, the second terminal of the first transistor coupled to the second terminal of the first resistor, to the second terminal of the second resistor, and to the first terminal of the fifth resistor;
a second transistor having a first terminal, a second terminal, and a control terminal, the second terminal of the second transistor coupled to the first terminal of the first transistor;
a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor;
a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor;
a fifth transistor having a first terminal, a second terminal, and a control terminal, the first terminal of the fifth transistor coupled to the second terminal of the third transistor, to the second terminal of the third resistor, and to the second terminal of the fourth resistor, the second terminal of the fifth transistor coupled to ground, and the control terminal of the fifth transistor coupled to the second terminal of the first resistor and to the second terminal of the second resistor; and
a sixth transistor having a first terminal, a second terminal, and a control terminal, the first terminal of the sixth transistor coupled to the second terminal of the first transistor, the second terminal of the first resistor, and to the second terminal of the second resistor, the second terminal of the sixth transistor coupled to ground, and the control terminal of the sixth transistor coupled to the second terminal of the third resistor and to the second terminal of the fourth resistor.

12. The apparatus of claim 6, wherein the combination circuitry further includes:
a first transistor having a first terminal, a second terminal, and a control terminal, the second terminal of the first transistor coupled to the second terminal of the first resistor, to the second terminal of the second resistor, and to the first terminal of the fifth resistor;
a second transistor having a first terminal, a second terminal, and a control terminal, the second terminal of the second transistor coupled to the first terminal of the first transistor;
a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor (Rb right), the control terminal of the third transistor coupled to the first terminal of the first transistor and to the second terminal of the second transistor;
a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor;
a seventh resistor having a first terminal and a second terminal, the first terminal of the seventh resistor coupled to the first terminal of the second transistor, and the second terminal of the seventh resistor coupled to the control terminal of the second transistor and to the control terminal of the fourth transistor;
a first capacitor having a first terminal and a second terminal, the first terminal of the first capacitor coupled to the first terminal of the seventh resistor, the second terminal of the first capacitor coupled to the second terminal of the seventh resistor;
an eighth resistor having a first terminal and a second terminal, the first terminal of the eighth resistor coupled to the second terminal of the seventh resistor, the control terminal of the second transistor, the control terminal of the fourth transistor, the second terminal of the eighth resistor coupled to the first terminal of the fourth transistor; and
a second capacitor having a first terminal and a second terminal, the first terminal of the second capacitor coupled to the first terminal of the eighth resistor, the second terminal of the second capacitor coupled to the second terminal of the eighth resistor.

13. The apparatus of claim 6, wherein:
the combination circuitry includes:
a first transistor having a first terminal, a second terminal, and a control terminal, the second terminal of the first transistor coupled to the second terminal of the first resistor, to the second terminal of the second resistor, and to the first terminal of the fifth resistor;
a second transistor having a first terminal, a second terminal, and a control terminal, the second terminal of the second transistor coupled to the first terminal of the first transistor;
a third transistor having a first terminal, a second terminal, and a control terminal, the first terminal of the third transistor coupled to the control terminal of the first transistor, the second terminal of the third transistor coupled to the second terminal of the third resistor, to the second terminal of the fourth resistor, and to the second terminal of the sixth resistor, the control terminal of the third transistor coupled to the first terminal of the first transistor and to the second terminal of the second transistor;
a fourth transistor having a first terminal, a second terminal, and a control terminal, the second terminal of the fourth transistor coupled to the first terminal of the third transistor and to the control terminal of the first transistor, and the control terminal of the fourth transistor coupled to control terminal of the second transistor;
a first capacitor having a first terminal and a second terminal, the first terminal of the first capacitor coupled to the second terminal of the first transistor, the second terminal of the first resistor, and the second terminal of the second resistor;
a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor;
a third capacitor having a first terminal and a second terminal, the first terminal of the third capacitor coupled to the second terminal of the second transistor, the control terminal of the third transistor, and the first terminal of the first transistor;
a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor;
a fifth transistor having a first terminal, a second terminal, and a control terminal, the first terminal of the fifth transistor coupled to the second terminal of the third transistor, to the second terminal of the third resistor, to the second terminal of the fourth resistor, and to the second terminal of the sixth resistor, the second terminal of the fifth transistor coupled to ground, and the control terminal of the fifth transistor coupled to second terminal of the first resistor and to the second terminal of the second resistor;
a sixth transistor having a first terminal, a second terminal, and a control terminal, the first terminal of the sixth transistor coupled to the second terminal of the first transistor, to the second terminal of the first resistor, to the second terminal of the second resistor, and to the first terminal of the fifth resistor, the second terminal of the sixth transistor coupled to ground, and the control terminal of the sixth transistor coupled to the second terminal of the third resistor and to the second terminal of the fourth resistor;
a seventh resistor having a first terminal and a second terminal, the first terminal of the seventh resistor coupled to the first terminal of the second transistor, and the second terminal of the seventh resistor coupled to the control terminal of the second transistor and to the control terminal of the fourth transistor;
a first capacitor having a first terminal and a second terminal, the first terminal of the first capacitor coupled to the first terminal of the seventh resistor, the second terminal of the first capacitor coupled to the second terminal of the seventh resistor;
an eighth resistor having a first terminal and a second terminal, the first terminal of the eighth resistor coupled to the second terminal of the seventh resistor, the control terminal of the second transistor, and to the control terminal of the fourth transistor, the second terminal of the eighth resistor coupled to the first terminal of the fourth transistor;
a second capacitor having a first terminal and a second terminal, the first terminal of the second capacitor coupled to the first terminal of the eighth resistor, the second terminal of the second capacitor coupled to the second terminal of the eighth resistor;
a third current source having an output;
a seventh transistor having a first terminal, a second terminal, and a control terminal, the first terminal of the seventh transistor coupled to the output of the third current source and to the control terminal of the seventh transistor, the control terminal of the seventh transistor coupled to the control terminal of the second transistor and to the control terminal of the fourth transistor; and
an eighth transistor having a first terminal, a second terminal, and a control terminal, the first terminal of the eighth transistor coupled to the second terminal of the seventh transistor and to the control terminal of the eighth transistor, the second terminal of the eighth transistor coupled to the reference terminal of the comparator.

14. A system comprising:
a communication channel having an output;
replica transmitter circuitry having an output;
combination circuitry including:
voltage to current converter circuitry including:
a first resistor having a first terminal and a second terminal, the first terminal coupled to the output of the communication channel;
a second resistor having a first terminal and a second terminal, the first terminal of the second resistor coupled to the output of the replica transmitter circuitry, the second terminal of the second resistor coupled to the second terminal of the first resistor;
a third resistor having a first terminal and a second terminal, the first terminal coupled to the output of the communication channel; and
a fourth resistor having a first terminal and a second terminal, the first terminal of the fourth resistor coupled to the output of the replica transmitter circuitry, the second terminal of the fourth resistor coupled to the second terminal of the third resistor;
virtual ground circuitry including:
a first transistor having a first terminal, a second terminal, and a control terminal, the second terminal of the first transistor coupled to the second terminals of the first resistor and second resistor;
a second transistor having a first terminal, a second terminal, and a control terminal, the second terminal of the second transistor coupled to the first terminal of the first transistor;
a third transistor having a first terminal, a second terminal, and a control terminal, the first terminal coupled to the control terminal of the first transistor, the second terminal of the third transistor coupled to the second terminals of the third resistor and the fourth resistor, the, and the control terminal of the third transistor coupled to the first terminal of the first transistor and to the second terminal of the second transistor; and
a fourth transistor having a first terminal, a second terminal, and a control terminal, the second terminal of the fourth transistor coupled to the first terminal of the third transistor and to the control terminal of the first transistor, the control terminal of the fourth transistor coupled to control terminal of the second transistor; and
receiver circuitry having an input, the input of the receiver circuitry coupled to the first terminal of the second transistor and to the first terminal of the fourth transistor.

15. The system of claim 14, wherein the second terminal of the first resistor is coupled to the second terminal of the second resistor at a first node, the second terminal of the third resistor and the second terminal of the fourth resistor are coupled at a second node, a signal on the output of the communication channel includes combination of a forward channel signal and a back-channel signal, a signal on the output of the replica transmitter circuitry includes the forward channel signal, and the voltage to current converter circuitry is to:
convert the signal on the output of the communication channel to current based on the first resistor;
convert the signal on the output of the replica transmitter circuitry to current based on the second resistor;
sum the output current of the communication channel with the output current of the replica transmitter circuitry at the first node to determine the back-channel signal, wherein the signal on the output of the communication channel at the first resistor is positive and the signal on the output of the replica transmitter circuitry at the second resistor is negative;
convert the signal on the output of the communication channel to current based on the third resistor;
convert the signal on the output of the replica transmitter circuitry to current based on the fourth resistor; and
sum the output current of the communication channel with the output current of the replica transmitter circuitry at the second node to determine the back-channel signal, wherein the signal on the output of the communication channel at the third resistor is negative and the signal on the output of the replica transmitter circuitry at the fourth resistor is positive.

16. The system of claim 14, wherein the second terminal of the first resistor is coupled to the second terminal of the second resistor at a first node, the second terminal of the third resistor and the second terminal of the fourth resistor are coupled at a second node, and the virtual ground circuitry:
generates a first virtual ground at the first node based on the first transistor and second transistor being cascoded and the first transistor being cross-coupled with the third transistor; and
generates a second virtual ground at the second node based on the third transistor and fourth transistor being cascoded and the third transistor being cross-coupled with the first transistor.

17. The system of claim 16, wherein the cross-coupled first and third transistors create a low impedance at the first terminal of the first transistor and first terminal of the third transistor.

18. The system of claim 14, wherein a signal on the output of the communication channel includes a combination of a forward channel signal and a back-channel signal, a signal on the output of the replica transmitter circuitry includes the forward channel signal, and the voltage to current converter circuitry is to sum the signal on output of the communication channel with the signal on the output of the replica transmitter circuitry in a current domain to determine the back-channel signal, the system further includes a biquad filter to reject any residual frequencies corresponding to the forward channel signal after the voltage to current converter circuitry sums the signals on the outputs of the communication channel and replica transmitter circuitry.

19. The system of claim 18, wherein the biquad filter includes:
a first capacitor having a first terminal and a second terminal, the first terminal of the first capacitor coupled to the second terminal of the first transistor, the second terminal of the first resistor, and the second terminal of the second resistor;
a second capacitor having a first terminal and a second terminal, the first terminal of the second capacitor coupled to the second terminal of the first capacitor, the second terminal of the second capacitor coupled to the second terminal of the third transistor, the second terminal of the third resistor, and the second terminal of the fourth resistor;
a third capacitor having a first terminal and a second terminal, the first terminal of the third capacitor coupled to the second terminal of the second transistor, the control terminal of the third transistor, and the first terminal of the first transistor; and
a fourth capacitor having a first terminal and a second terminal, the first terminal of the fourth capacitor coupled to the second terminal of the third capacitor, the second terminal of the fourth capacitor coupled to the second terminal of the fourth transistor, the control terminal of the first transistor, and the first terminal of the third transistor, wherein the first capacitor, second capacitor, third capacitor, and fourth capacitor are tunable to support different frequencies of the back-channel signal.

20. The system of claim 14, wherein a signal on the output of the communication channel is a single-ended signal, the combination circuitry further includes single to differential signal converter circuitry to convert the single-ended signal to a differential signal to balance a signal on an output at the first terminal of the second transistor with a signal on an output at the first terminal of the fourth transistor.

21. The system of claim 20, wherein the single to differential signal converter circuitry includes:
a fifth transistor having a first terminal, a second terminal, and a control terminal, the first terminal of the fifth transistor coupled to the second terminal of the third transistor, the second terminal of the third resistor, and the second terminal of the fourth resistor, the second terminal of the fifth transistor coupled to ground, and the control terminal of the fifth transistor coupled to second terminal of the first resistor and the second terminal of the second resistor; and
a sixth transistor having a first terminal, a second terminal, and a control terminal, the first terminal of the sixth transistor coupled to the second terminal of the first transistor, the second terminal of the first resistor, and the second terminal of the second resistor, the second terminal of the sixth transistor coupled to ground, and the control terminal of the sixth transistor coupled to the second terminal of the third resistor and the second terminal of the fourth resistor.
